(19) United States
(12) Patent Application Publication
(10) Pub. No.: US 2019/0213684 A1
(43) Pub. Date: Jul. 11, 2019

(54) INTEGRATED VEHICULAR MONITORING AND COMMUNICATION SYSTEM

(71) Applicant: ACCENTURE GLOBAL SOLUTIONS LIMITED, Dublin (IE)

(72) Inventors: Paul SUNDAR SINGH, Chennai (IN); Karthik KANTHIMATHINATHAN, Chennai (IN); Saranya THIRUNAVUKKARASU, Chennai (IN)

(73) Assignee: ACCENTURE GLOBAL SOLUTIONS LIMITED, Dublin (IE)

(21) Appl. No.: 15/867,452

(22) Filed: Jan. 10, 2018

(51) Int. Cl. G06Q 40/08; G07C 5/00; G07C 5/08; G06Q 10/00

(52) U.S. Cl. CPC G06Q 40/08; G07C 5/008; H04L 67/02; G06Q 10/20; G07C 5/0808; G07C 5/0841

(57) ABSTRACT

An integrated vehicular monitoring and communication system provides remote monitoring and diagnostics and analysis of vehicles. The system provides integration across many layers including on board units (OBUs) in vehicles, a telematics layer collecting OBU data, enterprise resource planning (ERP) applications, a data and analytics layer platform including data storage, and a mobility platform. The above integration enables monitoring and communications of vehicle data for servicing and determining productivity.

### TECHNICAL FIELD

This patent application relates generally to vehicular on-board diagnostic equipment, and more specifically to systems and methods for integrated vehicular monitoring and communications to capture and analyze drive patterns and enhance performance and processes.

### BACKGROUND

Most vehicles are equipped with on-board diagnostic equipment that acquire and collect information regarding vehicular performance. For example, if the check engine light appears on the dashboard of an automobile, a mechanic or technician servicing that automobile may attach a scanning device to the on-board diagnostic equipment. The scanning device will read one or more codes outputted by the on-board diagnostic equipment, which will indicate the one or more specific vehicular performance problems that triggered the check engine light. Because different vehicles have different types of on-board diagnostic equipment with varying capabilities or effects, it has become increasingly challenging to acquire, collect, and use vehicular performance information and perform data analytics for improved vehicular monitoring and communications.

### BRIEF DESCRIPTION OF DRAWINGS

Features of the present disclosure are illustrated by way of examples shown in the following figures. In the following figures, like numerals indicate like elements, in which:

FIG. 1 illustrates an integrated vehicular monitoring and communications system, according to an example;

FIG. 2 illustrates an architecture of the integrated vehicular monitoring and communication system, according to an example;

FIG. 3 illustrates communication touch points, according to an example;

FIG. 4 illustrates a data flow diagram showing information sent between components, according to an example;

FIG. 5 illustrates a method of integrated vehicular monitoring and communications, according to an example;

FIGS. 6A-6E illustrate screenshots of that may be shown in a dashboard, according to examples;

FIG. 7A illustrates a method for settlement of claims using an integrated vehicular monitoring and communications, according to an example;

FIG. 7B illustrates a method for settlement of claims using detailed vehicle data to determine tier classification, according to an example;

FIGS. 8A-8F illustrate a data flow diagrams showing information sent between components during settlement of claims using an integrated vehicular monitoring and communications, according to an example;

FIG. 9 illustrates an architecture of the integrated vehicular monitoring and communication system, according to another example; and

FIG. 10 illustrates an architecture of the integrated vehicular monitoring and communication system, according to another example.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

According to examples described herein, an integrated vehicular monitoring and communication system may provide remote monitoring, diagnostics, and analysis of vehicles. The integrated vehicular monitoring and communication system may provide integration across many subsystems, including, but not limited to, on-board units (OBUs) in vehicles, a telematics system that collects OBU data, an analytics platform including data storage, various enterprise resource planning (ERP) systems and applications, and a mobility platform. In some examples, the integrated vehicular monitoring and communication system may include an integrated ERP and customer relationship management (CRM) platform, or an integrated communications platform-as-a-service (CPaaS) platform with various Internet of Things (IoT) hubs, platforms, and interfaces. The integrated vehicular monitoring and communication system may enable strategic management of vehicles, as well as diagnostics of vehicles and improved analysis of vehicle data. For example, the system may provide many functionalities for vehicles, including vehicle tracking, repair and spare parts availability, service scheduling, on-call support, diagnostics, warranty support, and insurance calculations. The system may also generate a dashboard that shows vehicle metrics, current and historic, and may provide predictions and recommendations for vehicle maintenance generated from analyzing vehicle data and drive pattern.

Additionally, the integrated vehicular monitoring and communication system may also provide a machine-to-mobile system that allows different platforms to communicate. This multi-platform or multi-system communication capability may provide increased compatibility and utility. For example, such communications may enable and support more comprehensive mobile claims settlement functionalities using information and analysis from the integrated vehicular monitoring and communication system.

As stated above, most vehicles are equipped with OBUs that may acquire and collect information regarding vehicular performance. In current vehicle monitoring systems, for example, telematics is used to capture data from vehicles via OBUs wirelessly over a network. However, one technical problem with current systems is that different components do not typically integrate with other systems. For instance, there is a wide array of OBUs that may be used in vehicles, all with varying capabilities or effects. There are also company-specific telematics systems, where one telematics system may only gather data from vehicles that are made by that same company. These systems therefore do not gather data from other incompatible vehicles or proprietary OBUs. In addition, these OBUs and telematics systems do not interact with ERP systems or other external systems and applications, and are therefore highly limited in their capabilities.

The integrated vehicular monitoring and communication system of the present application may support interaction with many platforms and systems, and may collect, analyze, and output vehicle data in real-time or near real-time to web or mobile devices. An integration subsystem may facilitate communication with vehicles of different manufacturers and types. The integration subsystem may also communicate with one or more ERP systems, analytic platforms, data storage, mobility platforms, and other systems to provide the functionality described above and described in further detail below.

Moreover, the integrated vehicular monitoring and communication system may enable and support settlement of claims. This may be achieved using a mobile claims settlement functionality, for example, that uses information and analysis from the integrated vehicular monitoring and communication system. Using data from OBUs, such as diagnostics of vehicles, including speed, acceleration, tire tread depth, brake frequency, rotations per minute (RPMs), crash-to-safe ratio through distance calculations, drive patterns analysis, predictive analytics, and other information, the system may enable an insurance agent, policy holder, vehicle or parts supplier, or other interested party to process a settlement claim, such as a warranty or insurance claim. Specifically, the system may provide or facilitate various settlement claims processes or subprocesses. These may include, among other things, accident registration, insurance premium calculation, settlement claim processing, sensor filtering, accident analysis, accident prediction, safety management, etc.

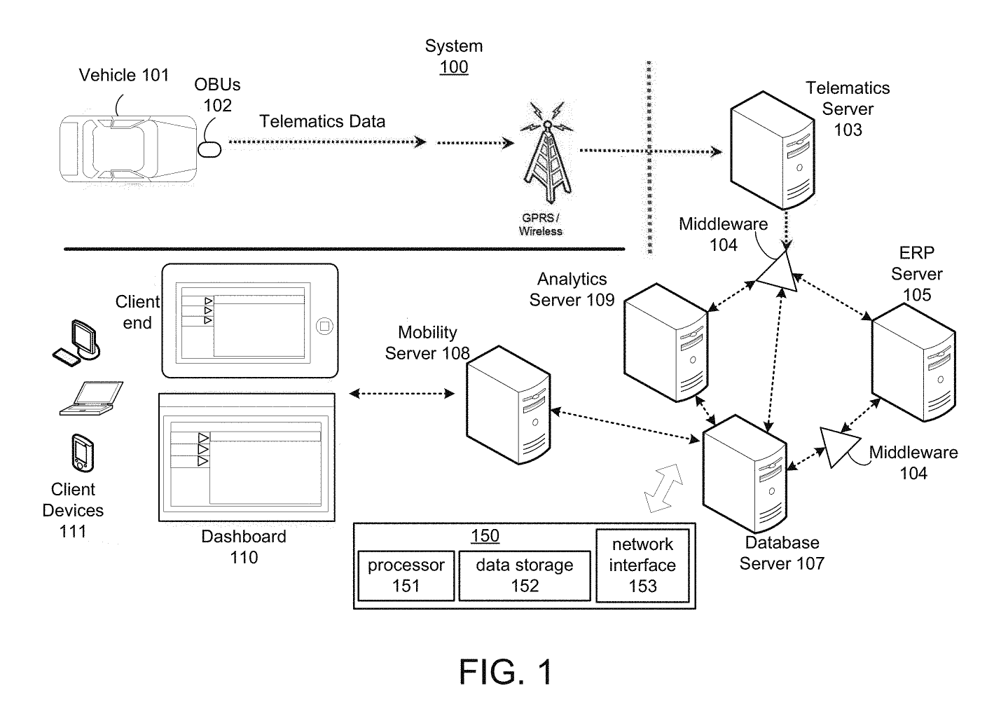

FIG. 1 illustrates an integrated vehicular monitoring and communications system 100, according to an example. The integrated vehicular monitoring and communications system 100 may be used to manage and monitor one or more vehicles. The system 100 may store information or be able to receive information from other sources for an entire fleet of vehicles. The system 100 may further be used to monitor any type of vehicle or vessel, such as automobiles, trucks, aircraft, motorcycles, bicycles, ships, aircraft, etc., and the managed vehicles/vessels need not be part of a fleet. The system 100 may also be able to monitor and communicate with any vehicle equipped with an on-board diagnostic equipment (e.g., on-board unit or OBU). The system 100 may also be used to manage and monitor equipment other than vehicles. In fact, any equipment for which data about the equipment may be collected and used may be monitored and managed by the system 100.

The integrated vehicular monitoring and communications system 100 may include a telematics server 103 that receives data (e.g., telematics data) from one or more OBUs 102 in one or more vehicles 101. The data may be pushed from the OBUs 102 or pulled by the telematics server 103, which may request the telematics data from the OBUs 102. To pull the telematics data, the telematics server 103 may poll the OBUs 102. The OBUs 102 may transmit the telematics data to the telematics server 103 via one or more networks, which may be wireless (e.g., cellular, satellite, Wi-Fi, etc.) or wired. The networks may be public networks, such as the Internet, or private networks.

The telematics data collected by the telematics server 103 may include any data collected by sensors, e.g., vehicle sensors or equipment sensors. For example, the sensor data may measure engine fluid levels, fuel consumption, engine temperature, hydraulic fluid levels, tire pressure, battery life, speed, acceleration, brake frequency, and other vehicle and equipment metrics that are measurable with sensors. The telematics data may also include vehicle location information.

The telematics data may further include information on whether the vehicle is being used according to predetermined constraints. These may include excessive tire misuse or wear, heavy towing loads, erratic or aggressive drive patterns, how harsh weather conditions affecting the vehicle, etc. For example, sensors may measure metrics associated with operation of the vehicle (e.g., weight load, speed, etc.) to determine if the vehicle is being used according to guidelines or predetermined requirements. Also, the sensors may be able to detect insufficient tread depth of tires on a vehicle and assess that they are below the recommended guidelines or predetermined requirements. The telematics data may also include service information generated by the OBUs 102 and any other information generated by the OBUs 102. The collected telematics data may be analyzed and utilized by a data and analytics platform, ERP system, including customer relationship management (CRM), and other applications.

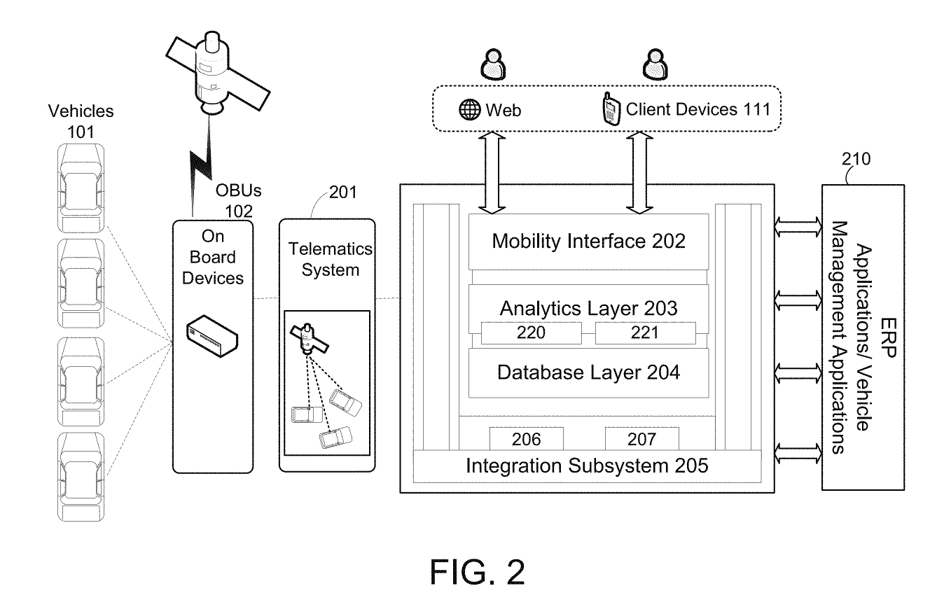

The following is a high-level description of the back-end systems of the integrated vehicular monitoring and communications system 100. A more detailed description of these back-end systems is provided with respect to FIG. 2 and other figures described below. In addition to the telematics server 103, the system 100 may include middleware 104, ERP server 105, database server 107, mobility server 108, and analytics server 109. The middleware 104 may provide integration between the various platforms and servers and is further described below. The ERP server 105 may include one or more application servers that host ERP applications, including a CRM application. The ERP applications may utilize the telematics data and may identify contact information for entities that are utilizing or responsible for managing the vehicles 101. The ERP applications may generate service tickets, check warranty information, order parts, process settlement claims, and perform other vehicle-related functions based on the telematics data and other information. The database server 107 may store the telematics data or other information. In one example, the database server 107 may handle both high transaction rates and complex query processing on the stored telematics data.

The mobility server 108 may be a mobility platform that facilitates interaction between client devices 111 and the system 100. The mobility server 108 may provide a dashboard 110, such as a graphical user interface, for display on the client devices 111. For example, the mobility server 108 may provide an Internet portal for client devices 111 to access the system 100 through the Internet.

The dashboard 110 may be accessible via a browser. The mobility server 110 may include a web server. The dashboard 110 may show a service ticket and vehicle information, for example, to a service technician. The dashboard 110 may receive a drill-down query for additional information for the vehicle, where the user may then be authenticated, and the mobility layer 202 may then send the query to the analytics and/or database servers to retrieve the additional information for the vehicle. The dashboard 110 may present the additional information via a screen in the dashboard if the user is authenticated. The dashboard 110 may provide various customizable arrangements to present information. For example, a consolidated view of information from multiple environments, including the ERP applications 110 and the analytics and database layers 203 and 204 may be displayed. The client devices 111 may include cellular phones, mobile computing devices, laptops, desktops, tablets, workstations, or other types of devices and computer systems. The analytics server 109 may process the telematics data and make vehicle service and diagnostic determinations, as well as facilitate the scheduling of maintenance, managing rental and warranty instances, processing of settlement claims, and performance of a variety of other functions related to the vehicles 101.

A single server is shown for each of the telematics server 103, ERP server 105, database server 107, mobility server 108 and analytics server 109. However, it should be appreciated that multiple servers may be used for each of these servers, and the servers may be connected via one or more networks. Also, the middleware 104 may include software hosted by one or more servers. Furthermore, it should be appreciated that some of the middleware 104 or servers may or may not be needed to achieve functionality. Other types of servers, middleware, systems and applications not shown may also be provided at the back-end to facilitate the features and functionalities of the integrated vehicular monitoring and communications system 100.

An example of hardware that may be used for any of the servers is shown as 150, which may include a processor 151, data storage 152 and network interface 153. The processor 151 may be an integrated circuit, and may execute software or firmware or comprise custom processing circuits, such as an application-specific integrated circuit (ASIC) or field-programmable gate array (FPGA). The data storage 152 may include volatile and/or nonvolatile data storage that may store data and software or firmware including machine-readable instructions. The software or firmware may include subroutines or applications that perform the functions of the system 100 and/or run one or more application that utilize data from the system 100. The server 150 may also include a network interface 153 to communicate with other servers, devices, or network elements via a network. Other various server components or configurations may also be provided.

FIG. 2 illustrates an architecture of the integrated vehicular monitoring and communication system, according to an example. The vehicles 101 and the OBUs 102 are shown. As discussed above, the OBUs 102 may record events occurring in the vehicles 101. The data from the OBUs 102 may be referred to as OBU data, telematics data, vehicle data, or vehicle state data. Multiple systems, subsystems, and layers in the architecture are shown.

A layer may include a platform and at least one application. An application may include software comprised of machine-readable instructions stored on a non-transitory computer readable medium and executable by a processor. The layers shown in FIG. 2 may be implemented by the corresponding servers shown in FIG. 1.

A platform may be an environment on which an application is designed to run. For example, a platform may include hardware to execute the application, an operating system (OS), runtime libraries, interfaces, etc. The application may be compiled to run on the platform. The runtime libraries may include low-level routines or subroutines called by the application to invoke some of behaviors, such as exception handling, memory management, etc., of the platform at runtime. A subsystem is similar to a platform and may include software and hardware to run various software or applications.

The ERP system may include an ERP application that may be used for vehicular monitoring and communications. For example, an ERP application may be, or may include, a CRM application that stores service technician information, customer information, vehicle manager information, etc., which may be used for vehicle monitoring and alerts. Another example of an ERP application may be a vehicle management application specifically designed to perform a vehicle management task, such as generating a service ticket, which may be based on information provided to the vehicular monitoring and communications application from the database and analytics layer, such as vehicle state data, vehicle ID, etc. In another example, an ERP application may be an application specifically designed to perform the processes of a settlement of a claim, such as a warranty or insurance claim, or the calculation of an insurance premium. The settlement of the claim may be based on information provided to the vehicular monitoring and communications application from the analytics and database layers 203 and 204, such as tire data, drive pattern analysis, crash-to-safe ratio, accident predictions, etc. It should be appreciated that an ERP application may be any application that processes data, and the processed data may be associated with vehicle management or business activities.

The ERP application may run on a different platform than the analytics and database layers 203 and 204. The integration subsystem 205 may facilitate communication and data transfer between the ERP applications 210 and the analytics and database layers 203 and 204. The analytics and database layers 203 and 204 are shown as different layers but may also be provided as a single layer referred to as the database and analytics layer that runs on the same platform.

The telematics system 201 may receive the OBU data from the OBUs 102 and transfer the OBU data to the analytics layer 203. The analytics layer 203 may analyze the OBU data received via the telematics service layer 201, and OBU data may be fed to the mobility layer 202 and an ERP application, which may be part of the ERP applications 210 for incident creation, such as alerts, maintenance, claims settlement, etc. The analytics layer 203 may process the OBU data and make vehicle diagnostic determinations, schedule maintenance, manage warranty and insurance issues, and perform a variety of other functions for monitoring and managing the vehicles 101.

The analytics layer 203 may analyze the OBU data to determine whether any actionable vehicle event occurs that invokes generation of an action related to the analyzed OBU data. For example, the analytics layer 203 may include a rules module 220 and an action generator 221, which may include machine-readable instructions executed by at least one processor. The rules module 220 may generate and store rules, and the rules may specify conditions for determining actionable vehicle events. An actionable vehicle event, for example, may be an event that is detectable from vehicle state data, which may include the OBU data. The actionable event may be associated with health, service, or operation of a vehicle, such as oil pressure below a threshold, tire pressure below a threshold, location of a vehicle within or outside predetermined geographic area, load or weight capacity of vehicle above a threshold, response to weather conditions, drive pattern analysis, actual or predictable accident, crash-to-safe ratio determinations, or any other vehicle-related event. The rules may specify one or more conditions to invoke one or more actions.

A simple example of a condition may be a measured metric from the OBU data that exceeds a threshold, which invokes an action, such as generating a service ticket or alert. Rules may be generated based on user input or other source. For example, a user may enter rules via the dashboard 110. In another example, a rule may be generated from historic analysis of OBU data, such as determining failure rates of parts based on historic analysis of data, predicting estimated failure from the historic analysis, and creating rules that specify parts maintenance schedules based on estimated failure times.

In another example, rules may be specified by other systems. The action generator 221 may determine whether an actionable vehicle event occurs based on at least one of the rules, and may execute an action if the actionable vehicle event is determined to occur. For example, the action generator 221 may determine whether vehicle service is needed based on the vehicle state data and at least one rule. The action generator 221 may determine whether a warranty claim can be processed based on the vehicle state data and at least one rule. The action generator 221 may also calculate an insurance claim or premium based on the vehicle state data and at least one rule. For instance, vehicle state data and the at least one rule may identify a driver in one of several driver classification “tiers.” Depending on the driver's tier, he or she may be eligible for points or discounts that are factored into an insurance premium or insurance claim determination.

The action generator 221 may invoke a warranty or insurance claim by an ERP application by sending vehicle state data and a request for a settlement claim to the ERP application if these actions are specified in the rule. The action generator 221 may execute other actions which may be specified in the rules. For example, the action generator 221 may determine whether the vehicle is not being used in accordance with stored parameters based on the vehicle state data and at least one rule. If the vehicle is determined as not being used in accordance with the stored parameters, the action generator 221 may generate an alert or notification. This alert or notification may be communicated to a client (e.g., owner, driver, or manager of the vehicle, insurance agent, warranty claims representative, etc.) determined to be responsible for monitoring the vehicle or assessing or facilitating the processing of the claim or premium. An ERP application may determine an appropriate client or party, and an alert may be generated via the dashboard 10 or sent via email, text message or some other type of message to a client device via the mobility layer 202. Any alerts may be sent in this or other manner. In some examples, the client may search for alerts in connection with a vehicle. The parameters may include, for example, maximum number of covered miles, maximum months of covers, terms of warranty or use, or other parameters. These parameters may be specified in warranty agreements or insurance policies for the vehicles.

Detection of the actionable vehicle event may cause the action generator 221 to send an instruction to the vehicle or client over a network. In an example, the instruction may be sent to an OBU as an electronic data interchange (EDI) message. In another example, the action generator 221 may determine whether the vehicle is being used outside of a previously agreed upon usage based on the vehicle state data (e.g., tire monitoring or drive pattern analysis) and at least one rule, and if the vehicle is determined as being used outside of the previously agreed upon terms (e.g., continued driving on low tire pressure that creates excessive tire wear or dangerous driving patterns), an alert or notice of such behavior may be delivered to the vehicle, client, or stored in ERP for future use (e.g., the processing of a claim or calculation of a premium).

The database layer 204 may store OBU data. In one example, the database server 107 may handle both high transaction rates and complex query processing on the stored telematics data. The database layer 204 may include a relational database, online analytical processing, or other data storage systems.

The mobility layer 202 may provide information regarding the vehicles 101 and OBU data and other equipment-related information from the enterprise applications, which may include dealer enterprise applications, to the Internet and client devices 111. The information may be presented via the dashboard 110 shown in FIG. 1. The mobility layer 202 may also receive information from client devices 111 and provide information to the appropriate system, subsystem, layer, or application. The ERP applications 210 may include CRM and/or other types of applications that may utilize OBU data. The ERP applications 210 may include vehicular monitoring and communications applications that generate alerts or notifications, check warranties and insurance terms, and other features and functions.

The integration subsystem 205 may integrate OBUs 102, ERP applications 210 and layers 202-204 and may include the middleware 104 shown in FIG. 1. The integration subsystem 205 may provide the capability to connect to other applications through different types of adapters built into the framework of the system 100. The integration subsystem 205 may include a mapping and transformation element 206 and a connectivity element 207 comprising machine-readable instructions executed by the least one processor.

The mapping and transformation element 206 may determine a format for the vehicle state data according to the destination and a source of the vehicle state data, and may transform the vehicle state data to the determined format. For example, mappings between sources and destinations may be stored in data storage for the integration subsystem 205. The mappings may include fields for data from a source and fields for the destination. For example, fields for OBU data may be determined, and the fields may vary depending on the manufacturer of the OBU. Fields for the destination may be determined. For example, the database layer 204 may have a set of fields for storing OBU data in the database. The ERP applications 210 may have a different set of fields. Some of the fields between the different platforms may be the same but some may be different. The mappings may specify how to map fields from the source to the destination. The mappings may specify field name, data type (e.g., integer, ASCII, etc.), field length, etc. The OBU data may be sent to one or multiple destinations, such as the database layer 204 and an ERP application. For each destination, the mapping and transformation element 206 may convert the format of the OBU data to the destination format as specified in the stored mappings for the source and destination, and the integration subsystem 205 may send the formatted data to the destination.

The connectivity element 207 may determine connectivity parameters to establish communication with a destination. Connectivity parameters may be stored for each destination. The connectivity parameters may specify a communication protocol used by the destination. Based on the type of connectivity and the communication protocol to be used during message transfer between systems, the connectivity element 207 may select a relevant adapter to establish communication between the systems. Some examples of the adapters used by the integration subsystem 205 are now described.

A file adapter may provide file based connectivity between applications. This adapter may also enable connecting to file servers through the file transfer protocol (FTP) to push and pull information to and from the file server. A web service adapter may provide Internet-based connectivity based on the Simple Object Access Protocol (SOAP), and may be used to communicate with any internal or external web application. A database adapter may provide an ability to communicate directly to any database of external or internal applications through, for example, Java Database Connectivity (JDBC). This adapter may be used when connecting to legacy systems or other incompatible systems that may be hosted on different platforms that use different protocols. Some examples of modules and mechanisms that may be used for connectivity in the system 100 may include a Remote Function Call (RFC), which is a call or remote execution of a remote function module in an external system, utilization of a document format, such as Intermediate Document (IDoc), for data transfers, and proxies, which are executable interfaces that are generated for the target application language, such as JAVA or Advanced Business Application Programming (ABAP).

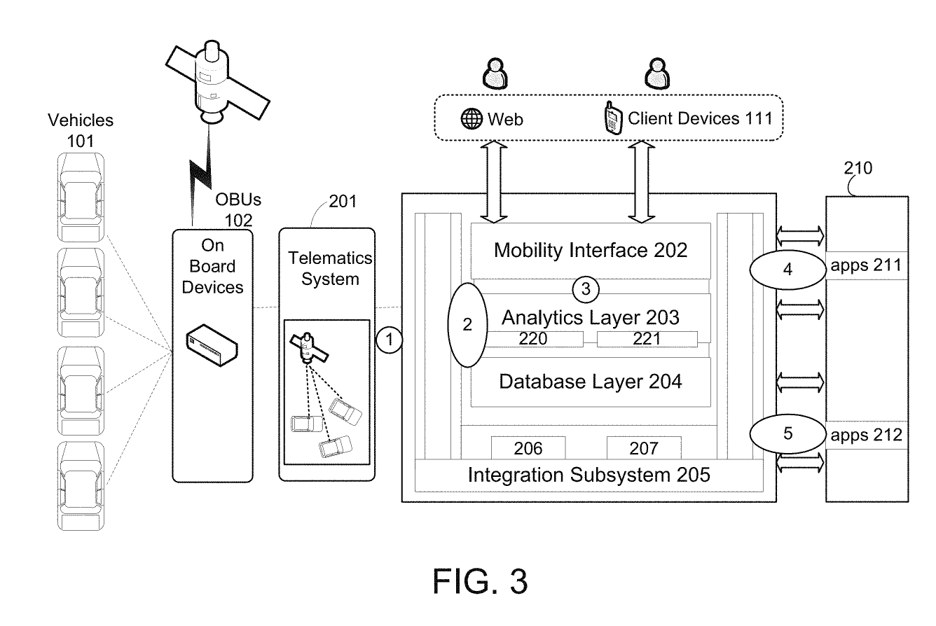

FIG. 3 illustrates communication touch points, according to an example. For example, FIG. 3 shows examples of communication touch points for the integration subsystem 205. The communication touch points are shown as black circles or ovals in FIG. 3 and may represent the connections or interfaces between layers, subsystems, applications, etc. The connections or interfaces for the communication touch points may be provided by the integration subsystem 205 and/or the platforms for the sources and destinations. Communication touch point 1 is depicted between the telematics service layer 201 and the integration subsystem 205. In one example, these connections maybe provided through web-service based communication. Data transfer between the telematics service layer 201 and the integration subsystem 205 may be through a web service using SOAP. In this example, the web service may be created and published in an application integration system, which may act as a web service provider. A Web Services Description Language (WSDL) file describing the functionality of the web service and a SOAP action uniform resource locator (URL) may be stored and used by the telematics service layer 201 for connecting to the integration subsystem 205.

In another example, connections for communication touch point 1 may be file-based. For instance, data from the telematics service layer 201 may be provided in the form of files. A server for the telematics service layer 201 may be configured with details, such as an Internet Protocol (IP) address and access credentials, and the FTP protocol may be used to transfer files to a server of the integration subsystem 205.

Communication touch point 2 is depicted between the integration subsystem 205 and the analytics layer 203, the mobility layer 202, and the database layer 204. In some examples, the analytics layer 203 and the database layer 204 may be provided as a single layer hosted on the same platform. The communication may depend on the type of system, subsystem, layer, platform, or application. If the layers are hosted by the same platform, such as all applications provided on a SAP™ platform, then a web service proxy may be used, and information may be exchanged between applications synchronously and/or asynchronously. If hosted by different platforms, a web service or direct database communication through a JDBC adapter may be used.

Communication touch point 3 is depicted between the analytics layer 203 and the mobility layer 202. When both analytics and mobility layers 203 and 202 are on the same platform, direct communication may be established between these applications through native connectivity without a need of integration middleware. If hosted by different platforms, a web service or a JDBC adapter, for example, may be used.

Communication touch points 4 and 5 are depicted between the integration subsystem 205 and applications that may be provided as applications 210. For example, the applications 210 may include ERP applications hosted on the same platform as the layers 202-204, and these applications are shown as apps 211 and connections are represented by communication touch point 4. In this case, the connections may use the communication protocol and formats of the platform. Communication touch point 5 may represent connections to apps 212 which may be hosted on a different platform than layers 202-204, and adapters specific to the different platform may be used for these connections. Communication touch point 6, between the mobility layer 202 and the client devices 111, may be facilitated by a web service managed by the mobility layer 202.

As stated above, one of the biggest problems with current systems is communication between different components that do not typically communicate with each other or integrate with other internal or external systems. By providing one or more adapters, the system 100 may reduce or eliminate the limitations associated with incompatible devices, platforms, and/or applications of traditional systems, and facilitate communications and enable features, such as processing of claim settlements, which involve detailed and precise communications and interaction between OBUs, company-specific telematics systems, databases, analytics engines, mobility servers, ERP systems, and/or other internal or external systems and applications to assess and resolve such settlement claims.

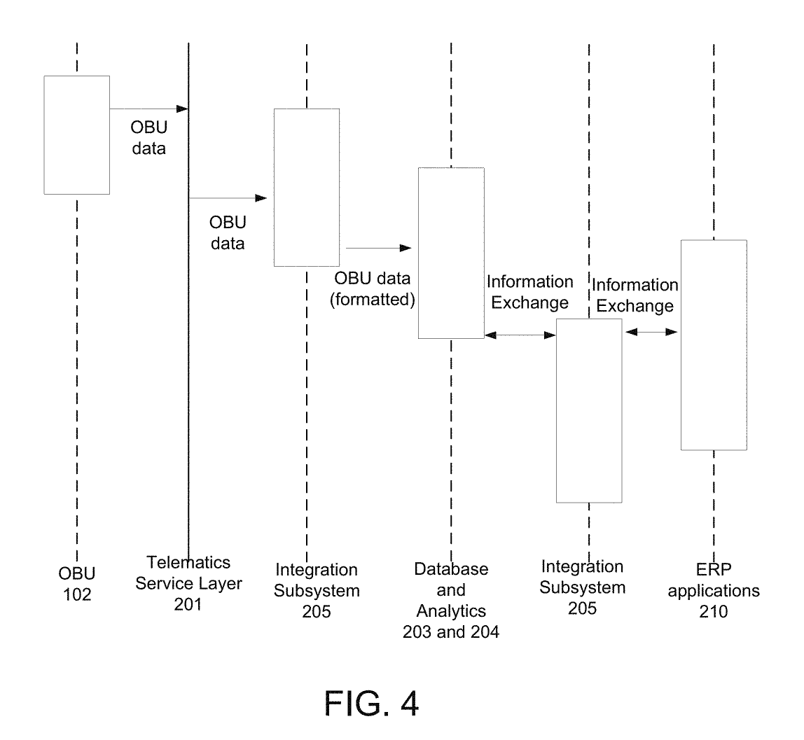

FIG. 4 illustrates a data flow diagram showing information sent between components, according to an example. The data flow diagram may depict some examples of information sent between components shown in FIGS. 1 and 2. For example, the OBUs 102 may send OBU data to the telematics service layer 201. The telematics service layer 201 may send the OBU data to the analytics and database layers 203 and 204 via the integration subsystem 205. The integration subsystem 205 may format the OBU data for storage in the database layer 204. Another destination for the OBU data may be an ERP application, and the data may be formatted for the ERP application. The analytics layer 203 may determine whether an actionable vehicle event occurs from vehicle state data comprising the OBU data, and execute an action based on at least one rule. The action may invoke an information exchange between the analytics and database layers 203 and 204 and the ERP application via the integration subsystem 205.

The integration subsystem 205 may facilitate information exchange through determined connectivity parameters and/or formatting for the destination. For example, this may be performed by mapping and transformation element 206 and the connectivity element 207. The information exchange may include sending vehicle state data from the analytics and database layers 203 and 204. It may also include sending a request to generate an alert or notification based on the vehicle state data to the ERP application. In an example where service is needed, the ERP application may generate a service ticket and identify a service technician to perform the service from a CRM application and send the service ticket with service technician information via the integration subsystem 205 to the analytics and database layers 203 and 204.

In an example where a warranty claim on tires is to be processed, the ERP application may store information about the vehicle, such as drive pattern, tire monitoring, and/or other warranty terms and conditions. The ERP application may identify details to process a settlement claim from a CRM application and send notification to a driver/owner, insurance agent, dealer, parts supplier, or other party via the integration subsystem 205 to the analytics and database layers 203 and 204. The analytics and database layers 203 and 204 may retrieve additional information, such as specific OBU data related to the vehicle or driver. Although not shown, the additional information may also be provided and presented via the dashboard 110. The dashboard 110 may be accessed by client devices 111. Also, other alerts or other messages may be sent to the client devices 111.

The integrated vehicular monitoring and communications system 100 100 may facilitate authentication of users for the system 100 and the ERP applications 210. Authentication may be performed by the mobility layer 202 via the dashboard 110. For instance, a user may provide login and password information via the dashboard 110. Access control lists may be stored for the system 100 and ERP applications 210 to determine whether a user is authorized to access information from those sources. The system 100 may grant authorization to users in other ways, such as two-step authentication, biometrics, or other security features.

As discussed above, the analytics and database layers 203 and 204 may detect incidents based on the collected OBU data and facilitate downstream actions and processes. The OBU data may include error codes that identify one or more problems of a vehicle and may be stored as an actionable vehicle event. Also, the analytics and database layers 203 and 204 may use rules to identify incidents that are actionable vehicle events that warrant actions to rectify the incidents or deemed useful for warranty or insurance settlement claims or premium calculations. Occurrence of an actionable event may be stored in the database layer 204. An ERP application, for example, may respond to the actionable event in real-time, near real-time, or when a threshold of data is accumulated in the database layer 204 or when triggered by a driver/owner of a vehicle, insurance agent, warranty claim representative, dealer, parts supplier, or other party who institutes a response or action.

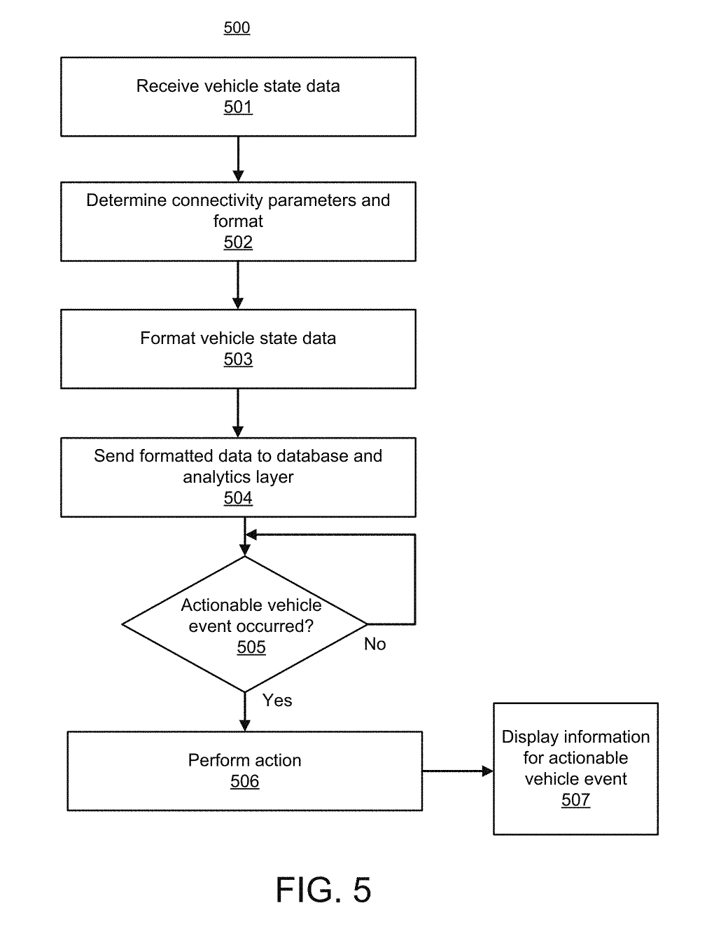

FIG. 5 illustrates a method of integrated vehicular monitoring and communications 500, according to an example. The method 500 is provided by way of example, as there may be a variety of ways to carry out the method described herein. Although the method 500 is primarily described as being performed by system 100 as shown in FIGS. 1-3, the method 500 may be executed or otherwise performed by other systems, or a combination of systems. The method 500 may also include information exchanged between the layers 202-204 and the ERP applications 210 facilitated by the integration subsystem 205. Each block shown in FIG. 5 may further represent one or more processes, methods, or subroutines, and functionality discussed in connection with one or more of the blocks may be implemented using and/or may include machine-readable instructions stored on a non-transitory computer readable medium and executed by a processor or other type of processing circuit to perform one or more operations described herein.

At 501, the integration subsystem 205 may receive vehicle state data from the telematics server 103, which may collect the vehicle state data, e.g., OBU data, from the OBUs 102. At 502, the integration subsystem 205 may determine connectivity parameters and one or more formats for storing data in the database layer 204. The connectivity parameters and format may be stored for multiple destinations and the integration subsystem 205 may determine and retrieve the connectivity parameters and the format for a particular destination. At 503, the vehicle state data may be formatted according to the determined format, and at 504, the formatted vehicle state data may be sent to the analytics and database layers 203 and 204 according to the determined connectivity parameters.

At 505, the analytics layer 203 may determine whether an actionable vehicle event occurred based on the vehicle state data and at least one rule. For example, the rules module 220 generates and stores rules, and the rules specify conditions for determining actionable vehicle events. The action generator 221 may determine whether an actionable vehicle event occurs based on at least one of the rules, and may execute an action if the actionable vehicle event is determined to occur. For example, the action generator 221 may determine whether a vehicle service is needed based on the vehicle state data and at least one rule. In another example, the action generator 221 may determine whether a warranty or insurance claim can be made based on the vehicle state data and at least one rule. In another example, the action generator 221 may determine whether an insurance premium calculation would be affected based on the vehicle state data and at least one rule.

At 506, if an actionable vehicle event is detected, then an action may be performed related to the actionable vehicle event. A relevant rule may specify the action. For example, the action may be to invoke service ticket generation by an ERP application. Here, the action generator 221 may send the vehicle state data for the detected actionable vehicle event and a request for a service ticket to the ERP application via the integration subsystem 205. The integration subsystem 205 may determine the connectivity parameters for the ERP application and formats the vehicle state data for the ERP application if needed, and sends the request and formatted data to the ERP application. The ERP application may then identify a service technician to assign, or automatically assign, the service ticket and generates the service ticket and sends the service ticket to the analytics and database layers 203 and 204, where the service ticket information may be stored. In another example, the ERP application may then determine a warranty or insurance claim may be possible or that one may have expired. Here, the ERP application may send the related information to the analytics and database layers 203 and 204, so that such information may be used at the institution of a settlement claim. In an example for insurance premium calculation, the ERP application may determine the actionable vehicle event impacts the calculation. Here, the ERP application may send the related information to the analytics and database layers 203 and 204, so that such information may be used at during the calculation of the premium. For example, good drivers may be instituted a tier 1 classification, which results in additional points or discounts counted towards insurance premiums.

At 507, information for the actionable vehicle event may be displayed via the dashboard 110. For example, the service ticket and additional vehicle information related to the service ticket may be presented via the dashboard 110. The additional vehicle information may be retrieved from the database layer 204 and may include service history and other information related to the vehicle in the service ticket. In the event the information for the actionable vehicle is related to a settlement claim (e.g., warranty or insurance claim), an option to proceed with processing the settlement claim may be provided, as described in further detail below.

Referring back to 505, if an actionable event is determined not to have occurred, future vehicle state data may continue to be monitored. For example, the OBUs 102 may periodically send vehicle state data, and the formatted vehicle state data may be periodically sent to the database and analytics layer 204 and 203. The analytics layer 204 may periodically make the determination of whether an actionable vehicle event occurred based on new vehicle state data and/or historic vehicle state data. The periodicity of monitoring and communicating vehicle state data may be configured and customized for each suited purpose. For example, for insurance claims, it may be monitored and communicated less frequently than for vehicular drive pattern analysis.

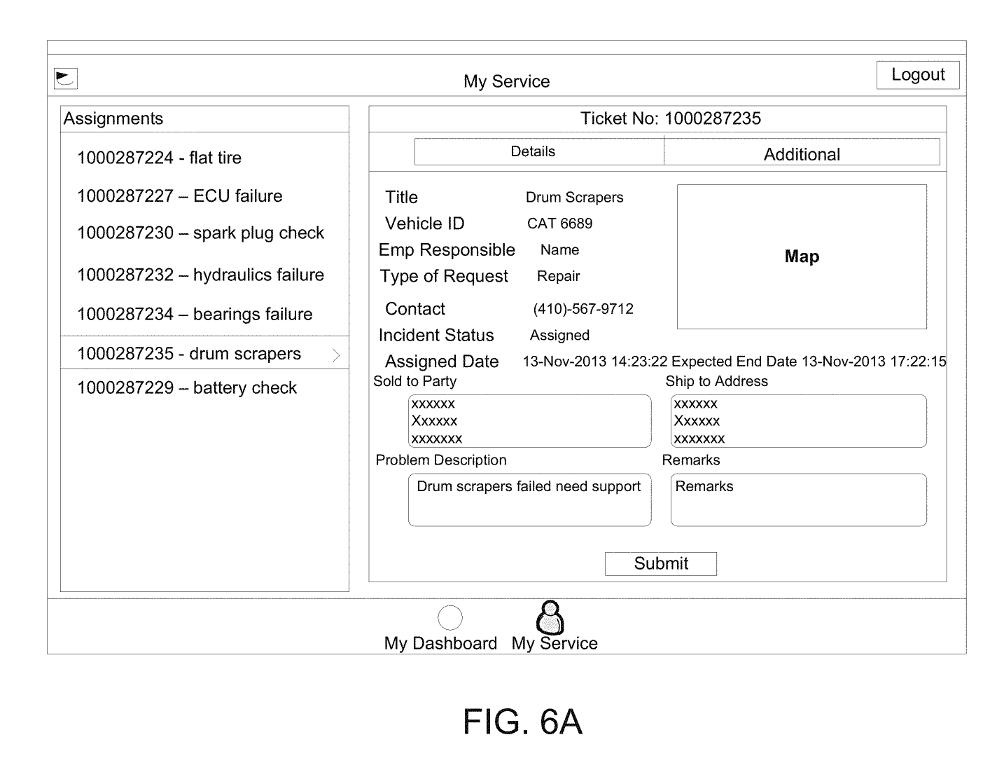

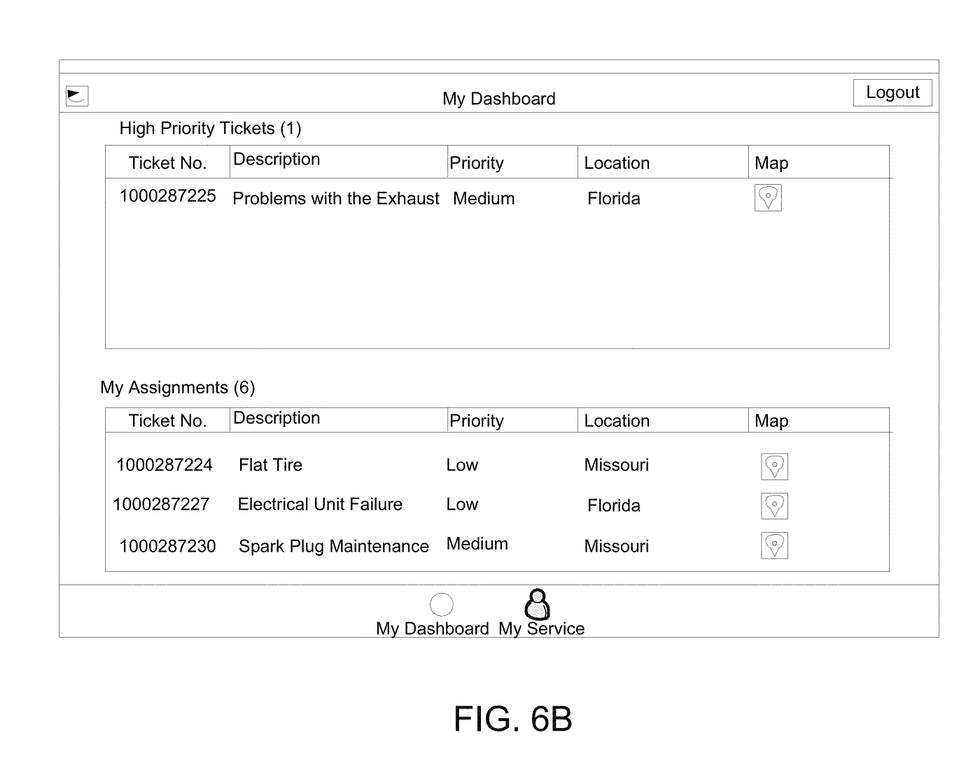

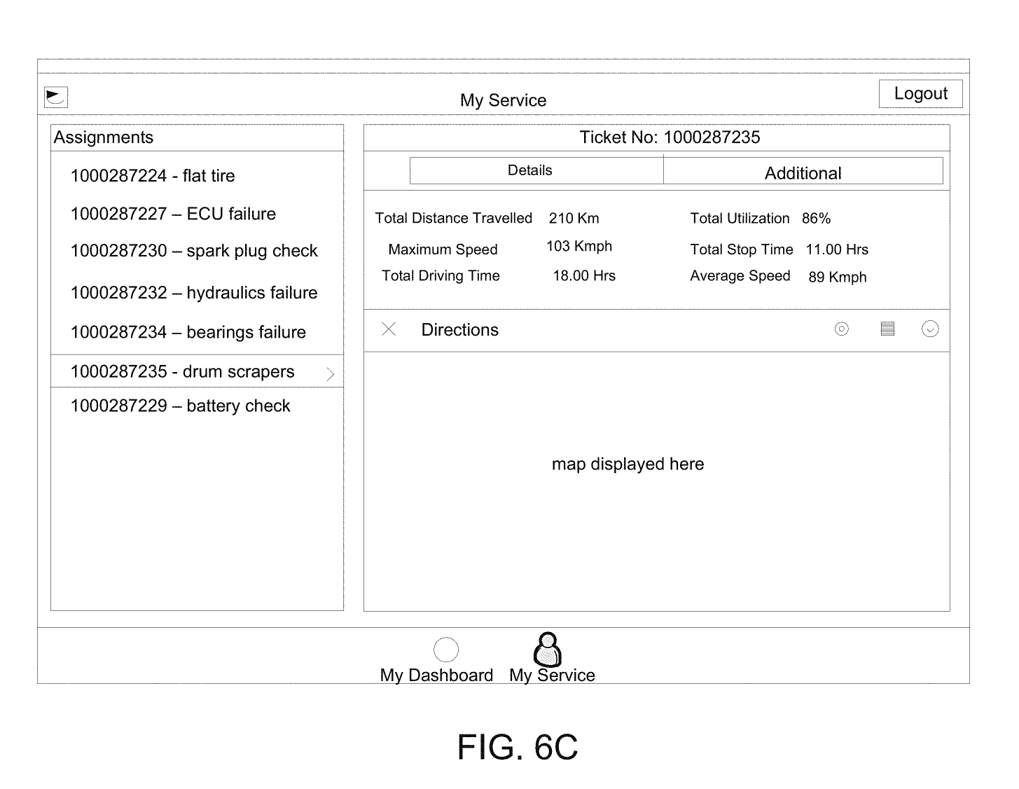

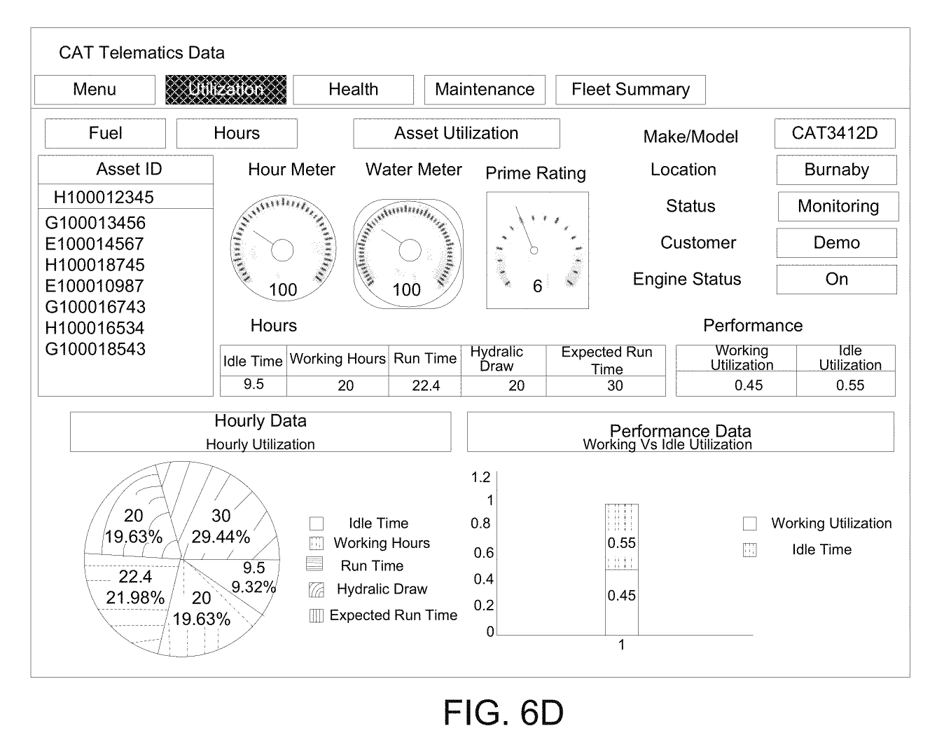

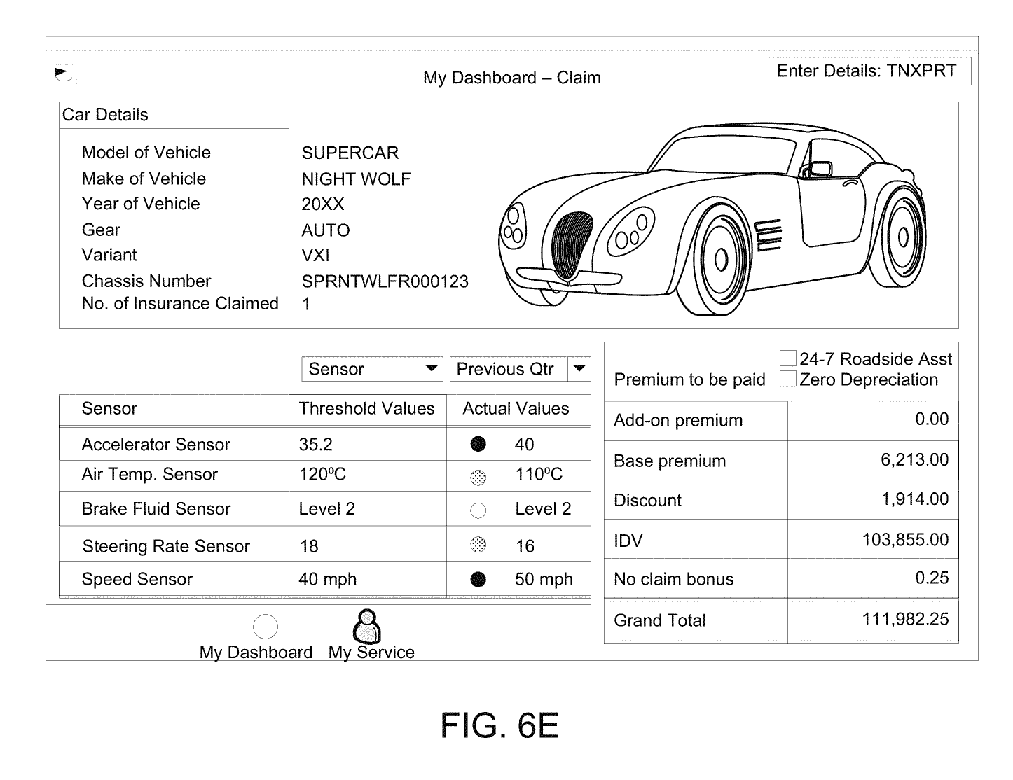

FIGS. 6A-6E illustrate screenshots of that may be shown in a dashboard, according to examples. FIG. 6A shows an example of a screen in the dashboard 110 that includes service ticket information. The service ticket information may be viewed by a manager, a service technician, or can be processed using a robotics process automation (RPA) tool. If a service technician is logged in, only the tickets for the service technician may be shown. Service ticket numbers may be shown on the left. A service ticket from the left may be selected to display additional information about service ticket, such as vehicle ID, employee or service technician responsible for the service, type of service request, contact information, incident status, and dates for when the service ticket was assigned and when the service is to be completed. A problem description may also be provided.

The service tickets may be prioritized and given a status, such as very high, high, medium, and low. Actions to be taken, such as servicing the vehicle, may be scheduled based on status and priority. The scheduling may be done by the ERP application and provided to the analytics and database layers 203 and 204, which may present the schedules via the dashboard 110. The dashboard 110 facilitates scheduling and prioritizing of incidents for service technicians that service the vehicles 101. Service tickets generated for incidents may be generated by an ERP application. The information for the service tickets and additional vehicle information may be viewed via the dashboard 110. A status of each service ticket may be shown, and geographic location of the vehicle and working condition of the vehicle may also be shown. The service tickets may be prioritized based on service agreements and past incidents.

FIG. 6B shows an example of a screen in the dashboard 110 that shows service tickets by priority. High priority tickets may be shown in the upper part of the screen and lower and medium priority tickets may be shown in the lower part of the screen. The ticket number, description, status and location may also be shown. A user may click on the map button to get a map to the vehicle.

The analytics and database layers 203 and 204 may track the status of the service tickets, such as whether the service has been performed, when the service was performed, what service was performed, and by whom. This information may be stored in the database layer 204 and provided to the ERP application.

Management of routine maintenance of the vehicles 101 may also be performed by the system 100. For example, a manager may log into the system 100 via the dashboard 110 to create and monitor scheduled maintenance, or the schedule may be provided by an ERP application to the analytics and database layers 203 and 204, which saves the schedule. The schedule may then be available for view via the dashboard 110. Each service technician may log in to view the schedule and the scheduled maintenance is tracked.

Information about the vehicle and scheduled maintenance may be viewed via the dashboard 110. The information may include graphical and quantitative information on the vehicle usage, which may include information for the fuel system, hydraulics, manufacturer, oil, buck draw capacity, lubrication system, etc. The information may include additional information regarding the history of failures and fixes for past failures. The information may also include tire wear data, drive pattern analysis, and other vehicular performance information obtained by one or more sensors and/or analyzed by the analytics layer and database layers 203 and 204.

FIG. 6C shows an example of a screen in the dashboard 110 that includes vehicle tracking information. Service tickets may be shown on the left. A user may click on the service ticket to get vehicle tracking information, driving summary and other information.

The analytics and database layers 203 and 204 may determine, from the global positioning system (GPS) data, whether a vehicle is in a location outside an authorized location. For example, a service agreement for a vehicle may specify that it may only be used in a predetermined geographic area. The analytics and database layers 203 and 204 determine from the GPS data whether the vehicle is being used outside the predetermined geographic area, and may generate alerts accordingly. In a settlement claims example, a warranty agreement or insurance policy may specific terms and conditions for use when, for example, processing a settlement of a claim or determining insurance premiums.

The analytics and database layers 203 and 204 may also determine utilization of each vehicle from the OBU data. The OBU data is analyzed to determine health of machines, need for support, spare parts replacement, overhaul information and running and idle time. The health and running time indicates productivity, which directly contributes to information on breakeven and return on investment for machine owners. The analytics layer 204 may make predictions on when maintenance is needed based on utilization and historic analysis of OBU data and failures. The maintenance may be automatically scheduled. Relevant information for settlement claims may also be stored for future use. Utilization information may be presented via a screen in the dashboard 110.

FIG. 6D shows an example of a screen in the dashboard 110 that includes utilization information. Asset IDs are shown, which may be a unique ID assigned to each vehicle. A user may select an asset ID to display the utilization information for the vehicle. Information, such as make and model, location, status, customer and engine status is shown. Hours of vehicle utilization are shown and a percentage of time the vehicle is utilized and idle are shown. Although FIGS. 6A-6D are screens generally directed to generation of service tickets, these screens may include or may be customized for other uses, such as processing claims settlement or insurance premium calculation, as described in more details below.

FIG. 6E shows an example of a screen in the dashboard 110 for calculation of an insurance premium. In this case, the vehicle is a car, and car details may be provided on the top left. For example, the screen may show make, model, and year of the vehicle, as well as other details, such as transmission/gear, chassis or VIN number, etc. The car details may also include number of insurance claims made on this vehicle. The car details may also include a visualization of the vehicle for a which a claim is being made. Although not shown, other vehicle information described in FIGS. 6A-6D or elsewhere may also be shown in the dashboard 110

At the bottom left of the screen, sensor data may be shown. For instance, various sensors on the vehicle may be listed, such as accelerator sensor, air temperature sensor, brake fluid sensor, steering rate sensor, speed sensor, etc. Corresponding threshold values, based on one warranty or insurance terms and/or rules or policies generated by and stored in the rules module 220, may also be displayed. Again, these terms or rules may specify conditions for determining actionable vehicle events, in this case, processing a settlement for a warranty claim or determining insurance premium costs. To the right of the threshold values may be the actual values from the listed sensors. In some examples, an indicator may show whether these actual values exceed, meet, or come close to exceeding the threshold values. In this screen, a solid or colored (red) indicator may show that the actual value for acceleration and speed exceeds the threshold value. For air temperature and steering rate, a dotted or colored (yellow) indicator may show that the actual values are very close to the threshold value. For the brake fluid sensor, a blank or colored (green) indicator may show the actual compliance is fully in compliance and not of concern. This and other information may be used to determine and calculate an insurance premium.

It should be appreciated that there may be other categories of information or data that can be shown other than sensor data. For instance, the screen may include a pull-down menu to select other information or data desired to be viewed on the dashboard 110. There may also be a pull-down to view information or data for other time periods or durations. In this case, the screen shows actual values over the previous quarter. Larger or smaller time periods may be selected or specified, all of which may affect settlement of a warranty claim, calculation of an insurance premium, or other claim or action.

At the bottom right of the screen, premium calculation information is presented. Here, various items may be considered for the final premium determination. For example, details regarding add-on premiums, base premiums, applicable discounts, insured declared value (IDV), no claim bonus, etc. may be used to calculate the grand total for premium to be paid. As described herein, a good driver may exhibit good drive patterns that warrant a good driver classification. Such a designation may include accumulation of points or discounts that may be applied to the insurance premium calculation. By using vehicle state data and generating drive patterns and other trends or behaviors of the vehicle or operator, a more comprehensive and accurate approach to warranty settlements, insurance claims, and insurance premiums may be provided.

As described herein, the integrated vehicular monitoring and communication system 100, among other things, may provide a machine-to-mobile system that allows different platforms to communicate. This multi-platform or multi-system communication capability may enable and support mobile claims settlement functionalities using information and analysis from the integrated vehicular monitoring and communication system.

The integrated vehicular monitoring and communication system 100 may provide a robust claims management system that may control, direct, process, and track warranties, for example, along a product life cycle. The system may also facilitate insurance claims, as well as insurance premium calculations. Currently, premium and warranty settlements are done through year-over-year (YoY) depreciation from insured declared value (IDV), and claims typically made based on accidents. A warranty settlement may generally involve multiple manual processes examining damage and parameters post incident or claim initiation. Conventional methods do not typically classify claims based on the factors of pre-incident human interaction, vehicle behaviors in unexpected/unprecedented events, or other factors. Also, conventional systems typically do not use drive patterns of vehicles to determine the auto insurance premiums or warranty settlements. The integrated vehicular monitoring and communication system 100, as described herein, may use different scenarios and previously unused or unrecorded information on vehicle attributes and/or drive pattern analysis to provide a more granularity in claims processing or insurance determinations. The integrated vehicular monitoring and communication system 100 may therefore use data from OBUs that communicate with analytics and database layers 203 and 204 and the ERP systems and applications 210, that manage warranties, to provide a more accurate and reliable approach to processing warranty settlements and insurance claims.

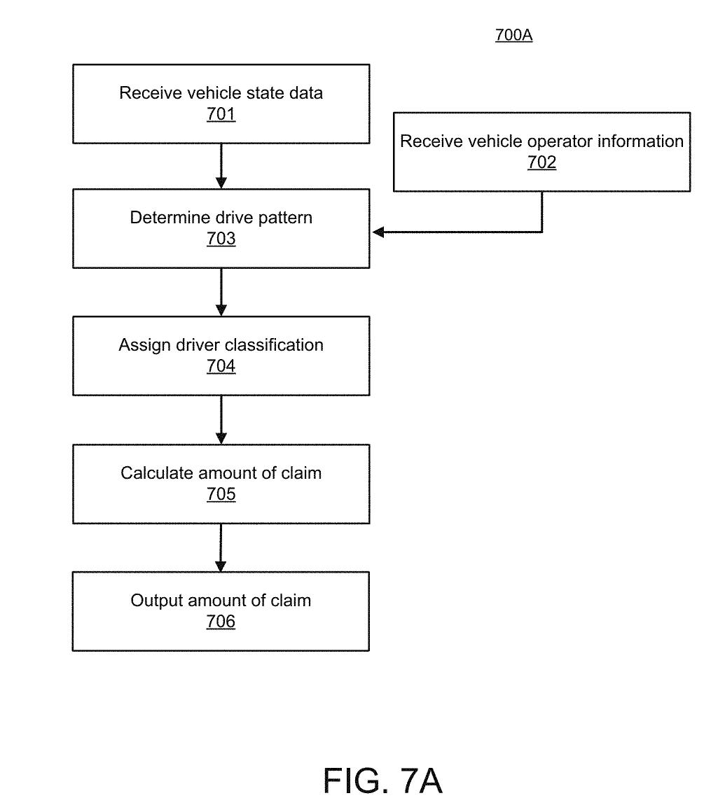

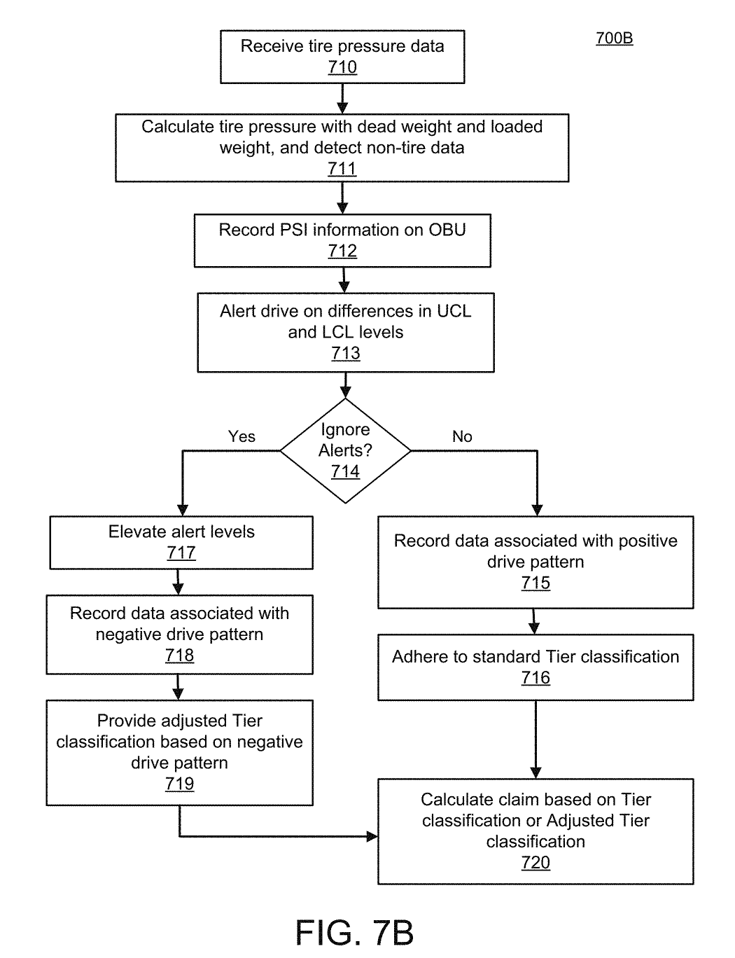

FIG. 7A illustrates a method for settlement of claims using an integrated vehicular monitoring and communications 700A, according to an example. The method 700A is provided by way of example, as there may be a variety of ways to carry out the method described herein. Although the method 700A is primarily described as being performed by system 100 as shown in FIGS. 1-3, the method 700A may be executed or otherwise performed by other systems, or a combination of systems. The method 700A may also include information exchange between the layers 202-204 and the ERP applications 210 facilitated by the integration subsystem 205. Each block shown in FIG. 7A may further represent one or more processes, methods, or subroutines, and one or more of the blocks may include machine-readable instructions stored on a non-transitory computer readable medium and executed by a processor or other type of processing circuit to perform one or more operations described herein.

At 701, the integration subsystem 205 may receive vehicle state data from the telematics server 103, which may collect the vehicle state data, e.g., OBU data, from the OBUs 102. At 702, the integration subsystem 205 may receive vehicle operator information. This may include identification of a driver of the vehicle. The identification may include a driver identifier, such as name, address, license number, biometric data, or other identifying information. The integration subsystem 205 may determine connectivity parameters and a format for storing data in the database layer 204. The connectivity parameters and format may be stored for multiple destinations and the integration subsystem 205 may determine and retrieve the connectivity parameters and the format for a particular destination.

At 703, the vehicle state data may be used to perform drive pattern analysis of the driver associated with the vehicle. It should be appreciated that the vehicle state data may be formatted according to the determined format to perform the analysis. The formatted vehicle state data and the drive pattern analysis may be sent to the analytics and database layers 203 and 204 according to the determined connectivity parameters.

The drive pattern analysis may involve recorded instances of vehicle operation and determining and analyzing trends and patterns in the vehicle operator. For example, the analytics and database layers 203 and 204 may collect vehicle state data, such as speed, acceleration, tire pressure, tread depth, brake frequency, airbag deployment, auto-braking initiation, fuel consumption, weight or load capacity, etc., over multiple instances (e.g., 50) and over a period of time (e.g. months). The number of instances and period of time may vary. However, the more instances collected over a longer of time may generate more accurate and reliable patterns and trends.

At 704, the analytics layer 203 may assign a driver classification for the operator of the vehicle based on the drive pattern analysis, vehicle state data, and vehicle operator information. In one example, driver classification may be based on a tiered structure of three (3) classes. Tier classification of vehicle operators may be a part advanced mobile auto integration that brings data-driven analytics to the claims settlement process. A sample three-tier driver classification is provided below in Table 1.

TABLE 1
Three-Tier Driver Classification

| | |
|---|---|
| Tier 1 | Excellent driver: extremely reliable; rule abiding and safe driver; incurs |
| | little to non-existent incidents, accidents, or collisions, and to some are |
| | incurred, they are usually minor; demonstrated years of consistently |
| | good driving patterns; maintains vehicle well |
| Tier 2 | Good driver: relatively consistent driver; generally obeys rules and laws, |
| | but may speed on occasion; maintains vehicle, but sometimes late with |
| | routine maintenance; incurs some incidents, accidents, or collisions, but |
| | are usually mild not major; lacks driving experience, under 5 years |
| Tier 3 | High-risk driver: Rash, unsafe, or inexperienced driver; mostly drives |
| | above speed limit; several incidents of drunken driving recorded; |
| | frequency of incidents on the higher side, where incidents tend to mild |
| | to major and completely preventable; does not maintain vehicle well, |
| | misses many routine vehicles servicing appointments |

At 705, the analytics and database layers 203 and 204, together with the ERP application, may calculate an amount of a claim based on the drive pattern analysis. The claim may be a warranty settlement claim, an insurance claim, or an insurance premium calculation. Other claims or actions may also be provided. In one example, a vehicle operator's classification may be grounds to provide points or discounts in claims settlement or insurance premium calculation. For instance, Tier 1 operators may receive a 20% discount for their excellent record of good driving patterns and pay 80% of an insurance premium. Tier 2 operators, who are relatively good drivers, may receive a 10% discount. Tier 3 operators may not receive any discounts, and may be considered as too high-risk to keep under a current policy. Other option may need to be considered for operations in this classification. Driving pattern and vehicle features are typically independent things and typically not considered this granularly in insurance premium calculations, but the integrated vehicular monitoring and communications system 100 may bring this information using advanced analytics and data processing to build a more robust claims settlement or insurance premium approach.

At 706, the calculated amount of the claim may be outputted for display via the dashboard 110. For example, if the claim is an insurance premium calculation, the insurance premium amount may be presented via the dashboard 110 to a client. The client may be a mobile device accessible by an owner of the vehicle requesting a quote or seeking to renew his or her policy. The client may also be a computing device accessible by an insurance agent. The insurance agent may represent a company that current insures the vehicle owner, or the insurance agent may be a prospective insurer. The additional vehicle information or other vehicle state data may also be displayed at the dashboard 110.

It should be appreciated that various aspects of drive patterns may be considered when actual classification is performed. For example, an accident is typically an unforeseen, unknown, or unanticipated event that occurs when multiple factors come together, e.g., beyond one's control, with influence of surrounding objects, etc. Since vehicles may have reflective metallic bodies, photographs taken in such an uncontrolled accident may help predict the type of claim to be processed. In one scenario, a tire burst may be a cause for a death claim. FIG. 7B illustrates a method for settlement of claims using detailed vehicle data to determine tier classification 700B, according to an example.

In method 700B, a vehicle may be driven under different tire pressures. An upper control limit (UCL) may be at 90% and a lower control limit (LCL) may be measured at 60% for a tire pressure monitoring system of that vehicle. At 710, the OBU may receive tire pressure data. For instance, the OBU may collect different pressures (e.g., pressure per square inch (PSI)) for the vehicle at various points relative to UCL and LCL. At 711, the tire pressure may be calculated with dead weight and with loaded weight. The integration subsystem 205 may also detect non-tire data to use in its calculations. At 712, the PSI information may be recorded by the OBU. If the data indicates the tire is losing pressure, the integration subsystem 205 may alert the driver on differences in UCL and LCL levels, as shown in 713. For example, if a driver of the vehicle is warned, via notifications, that tire pressure is dipping below the UCL at 10%, 15%, 20%, etc., the driver may be expected to perform actions commensurate with these warnings. At 715, the driver may heed these alerts and perform necessary actions, such as slow down the vehicle, demonstrating positive driving behavior. In this case, at 716, standard tier classification may apply when such positive drive patterns are identified.

However, this may not occur and a driver may reject or ignore of these alerts. At 717, elevated alert levels and warnings may be provided to the vehicle or driver to indicate decreased tire pressure. If the tire pressure becomes 8 PSI below the mandatory tire pressure, for example, the recorded data may also be compared with other non-tire data, such as surface, temperature, road condition, speed, location, etc. This may help identify whether the non-response by the driver to these warnings may be warranted. There may be reasons why tire pressure has decreased. The surface sensors in the deflating tires may detect the impact on the tire for monitoring the pressure. Increase and reduction of temperature in the environment may contribute to the reduction of pressure. Load factor may be another reason. At 718, if the tire is actually in trouble and the alerts are not false alarms based on the recorded data, it may be determined that the driver is exhibiting negative drive pattern, requiring adjustment to his or her Tier classification, as shown in 718, ultimately affecting his or her subsequent warranty or claim request at 720.

In an example, the non-tire data may be accounted for as “external conditional forces” which attributes to (x) factor of the variable “Claim_attained,” and “internal influential forces” may impact “X*factor of claim_attained,” which may be expressed as follows:

Claim attained factor=Sum of (“internal influential forces+(1/external conditional forces)).

These considerations may change a claims process by detecting legitimate incidents. They may also help identify potential for fraudulent claims. For example, such information and data may be recorded in the OBU and may use natural language processing (or other processing techniques) to interact with analytics:

% of on factor−P(U_{i,j}<UCL)=Σ[U_{i,j,Time to Collide/Crash<UCL}]Σ[U_{i,j}],

where I, J is the time series of interaction which instants between the alarm to crash. Time to collision occurs as an aggregation of indicators. This may be instantaneous or a series of incidents through a time period report. The “% of on factor” may contribute to claim amount, all of which affect Tier, classification, and/or output of claims.

Warranty and claim of the tire during the crash or death claim may be attached to manufacturer inspection. The tires when brought back to the facility for inspection may undergo different levels of inspection. Using sensor data collected over a period and instances from vehicle components may help build a decision tree for classification and establish range of the predicted values as shown below in Table 2. Actual readings and data from the OBU may provide a case for outliers, which are handled through analytics layer 203. For example, if a blown tire is attributed to a vehicle failure or accident, the sensors in the tire (like the tire pressure monitoring system (TPMS)), may provide actual data captured during the period of number of driving hours when the tire pressure was lower even after the alert was provided. This data may then be classified as outliers. These outliers may provide rescheduling of the Tier classification when a driver is ranked in Tier 1 and can be pushed to Tier 2 based on the data. These contribute to % of On factor which are multiplied to claim calculation by the warranty analysts and insurance providers.

TABLE 2
Recorded Data Table for Classification Adjustment

| | | | | | | | % | % | No | % |
|---|---|---|---|---|---|---|---|---|---|---|
| State or | Freeway | Freeway | Freeway | Divided | Undivided | | of | of | of | of on |
| territory | (rural) | (trucks) | (urban) | (rural) | (rural) | Residential | UCL | La | event | factor |
| Alabama | 70 mph | | 55-65 mph | 65 mph | 45-55 mph | 20-25 mph | 10 | 10 | 50 | 4-8% |
| | (113 km/h) | | (89- | (105 km/h) | (72- | (32- | | | | |
| | | | 105 km/h) | | 89 km/h) | 40 km/h) | | | | |
| Alaska | 65 mph | | 55-65 mph | 55-65 mph | 45-65 mph | 20-25 mph | 10 | 10 | 50 | 4-8% |
| | (105 km/h) | | (89- | (89- | (72- | (32- | | | | |
| | | | 105 km/h) | 105 km/h) | 105 km/h) | 40 km/h) | | | | |
| Arizona | 65-75 mph | | 55-65 mph | 55-65 mph | 45-65 mph | 20-25 mph | 10 | 10 | 50 | 4-8% |
| | (105- | | (89- | (89- | (72- | (32- | | | | |
| | 121 km/h) | | 105 km/h) | 105 km/h) | 105 km/h) | 40 km/h) | | | | |
| Arkansas | 70-75 mph | 70 mph | 60-65 mph | 65 mph | 55-65 mph | 30 mph | 10 | 10 | 50 | 4-8% |
| | (113- | (113 km/h) | (97- | (105 km/h) | (89- | (48 km/h) | | | | |
| | 121 km/h) | | 105 km/h) | | 105 km/h) | | | | | |
| California | 65-70 mph | 55 mph | 50-65 mph | 65 mph | 55-65 mph | 25-30 mph | 10 | 10 | 50 | 4-8% |
| | (105- | (89 km/h) | (80- | (105 km/h) [8] | (89- | (40- | | | | |
| | 113 km/h) | | 105 km/h) | | 105 km/h) | 48 km/h) | | | | |
| Hawaii | 55-60 mph | | 35-50 mph | 45-55 mph | 45-60 mph | 25 mph | 10 | 10 | 50 | 4-8% |
| | (89- | | (56-80 km/h) | (72- | (72- | (40 km/h) | | | | |
| | 97 km/h) | | | 89 km/h) | 97 km/h) | | | | | |
| Idaho | 70-80 mph | 70 mph | 60-65 mph | 65-70 mph | 55-70 mph | 25-30 mph | 10 | 10 | 50 | 4-8% |
| | (113- | (113 km/h) | (97- | (105- | (89- | (40- | | | | |
| | 129 km/h) | | 105 km/h) | 113 km/h) | 113 km/h) | 48 km/h) | | | | |
| Illinois | 70 mph | | 45-70 mph | 65 mph | 55 mph | 20-30 mph | 10 | 10 | 50 | 4-8% |
| | (113 km/h) | | (72- | (105 km/h) | (89 km/h) | (32- | | | | |
| | | | 113 km/h) | | | 48 km/h) | | | | |
| Kentucky | 70 mph | | 55-70 mph | 65 mph | 55 mph | 25-45 mph | 10 | 10 | 50 | 4-8% |
| | (113 km/h) | | (89- | (105 km/h) | (89 km/h) | (40- | | | | |
| | | | 113 km/h) | | | 72 km/h) | | | | |
| Louisiana | 70-75 mph | | 50-70 mph | 55-65 mph | 45-55 mph | 20-45 mph | 10 | 10 | 50 | 4-8% |
| | (113- | | (80- | (89- | (72- | (32- | | | | |
| | 121 km/h) | | 113 km/h) | 105 km/h) | 89 km/h) | 72 km/h) | | | | |
| Maine | 70-75 mph | | 50-65 mph | 45-55 mph | 45-55 mph | 25 mph | 10 | 10 | 50 | 4-8% |
| | (113- | | (80- | (72- | (72- | (40 km/h) | | | | |
| | 121 km/h) | | 105 km/h) | 89 km/h) | 89 km/h) | | | | | |
| Maryland | 65-70 mph | | 40-65 mph | 55 mph | 50-55 mph | 20-25 mph | 10 | 10 | 50 | 4-8% |
| | (105- | | (64- | (89 km/h) | (80- | (32- | | | | |
| | 113 km/h) | | 105 km/h) | | 89 km/h) | 40 km/h) | | | | |
| Nevada | 70-80 mph | | 55-65 mph | 65-75 mph | 55-70 mph | 20-30 mph | 10 | 10 | 50 | 4-8% |
| | (113- | | (89- | (105- | (89- | (32- | | | | |
| | 129 km/h) | | 105 km/h) | 121 km/h) | 113 km/h) | 48 km/h) | | | | |
| | [24][25][26] | | | | | | | | | |
| New Jersey | 65 mph | | 50-65 mph | 55 mph | 30-55 mph | 20-35 mph | 10 | 10 | 50 | 4-8% |
| | (105 km/h) | | (80- | (89 km/h) | (48- | (32- | | | | |
| | | | 105 km/h) | | 89 km/h) | 56 km/h) | | | | |
| New Mexico | 75 mph | | 55-75 mph | 55-75 mph | 55-65 mph | 20-55 mph | 10 | 10 | 50 | 4-8% |
| | (121 km/h) | | (89- | (89- | (89- | (32- | | | | |
| | | | 121 km/h) | 121 km/h) | 105 km/h) | 89 km/h) | | | | |
| New York | 65 mph | | 35-55 mph | 45-55 mph | 35-55 mph | 20-45 mph | 10 | 10 | 50 | 4-8% |
| (state) | (105 km/h) | | (56-89 km/h) | (72- | (56- | (32- | | | | |
| | | | | 89 km/h) | 89 km/h) | 72 km/h) | | | | |
| North | 65-70 mph | | 50-60 mph | 55-60 mph | 55 mph | 20-35 mph | 10 | 10 | 50 | 4-8% |
| Carolina | (105- | | (80-97 km/h) | (89- | (89 km/h) | (32- | | | | |
| | 113 km/h) | | | 97 km/h) [33] | | 56 km/h) | | | | |
| North | 75 mph | | 55-75 mph | 70 mph | 55-70 mph | 20-25 mph | 10 | 10 | 50 | 4-8% |
| Dakota | (121 km/h) | | (89- | (113 km/h) | (89- | (32- | | | | |
| | | | 121 km/h) | | 113 km/h) | 40 km/h) | | | | |

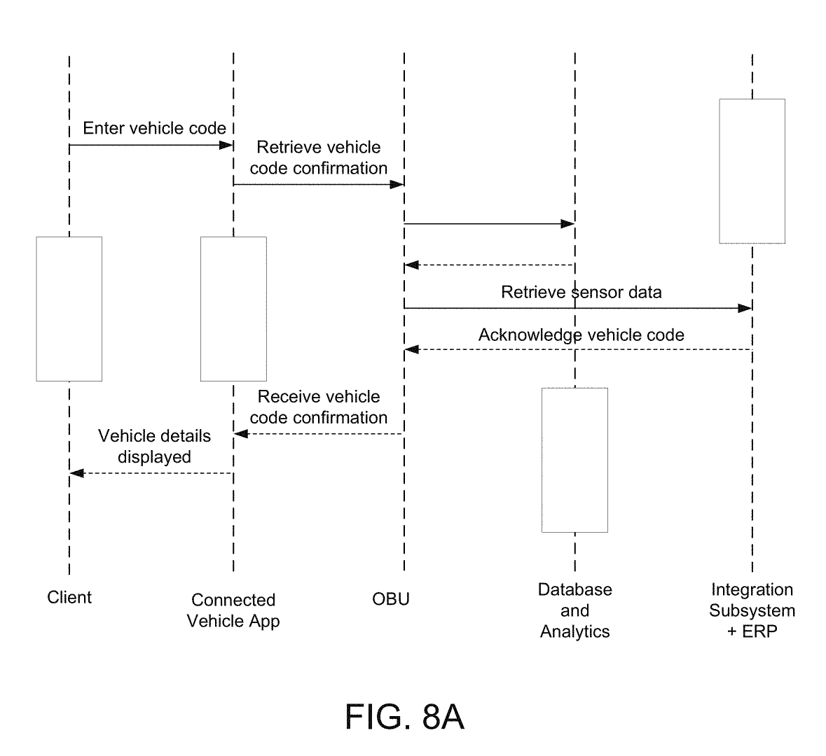

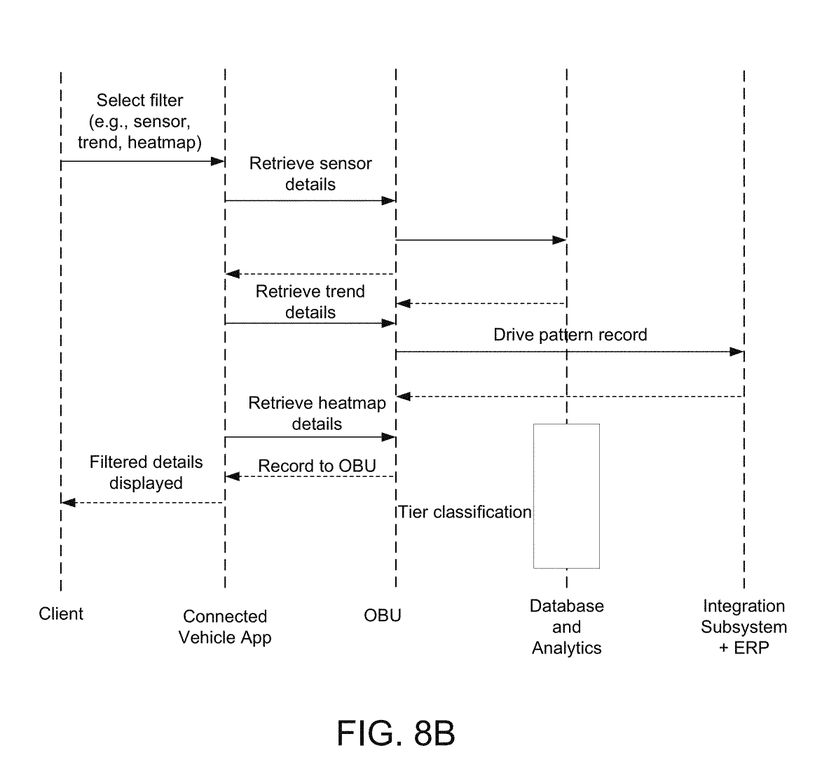

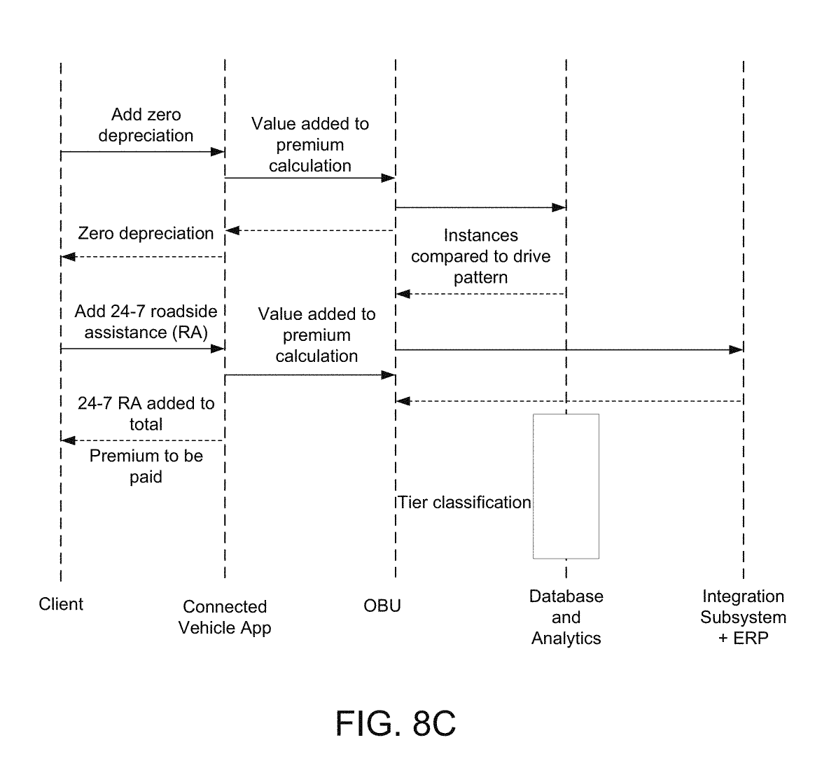

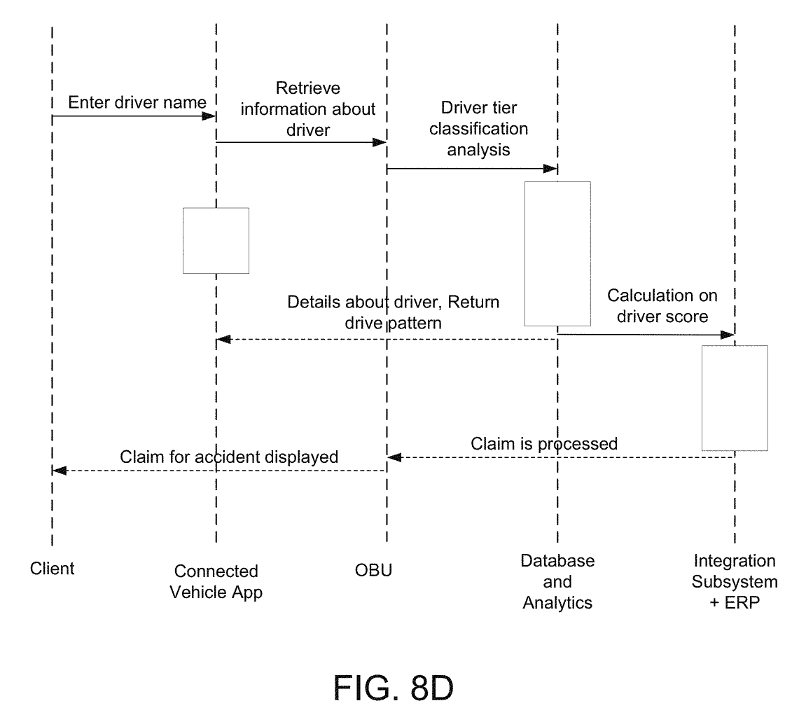

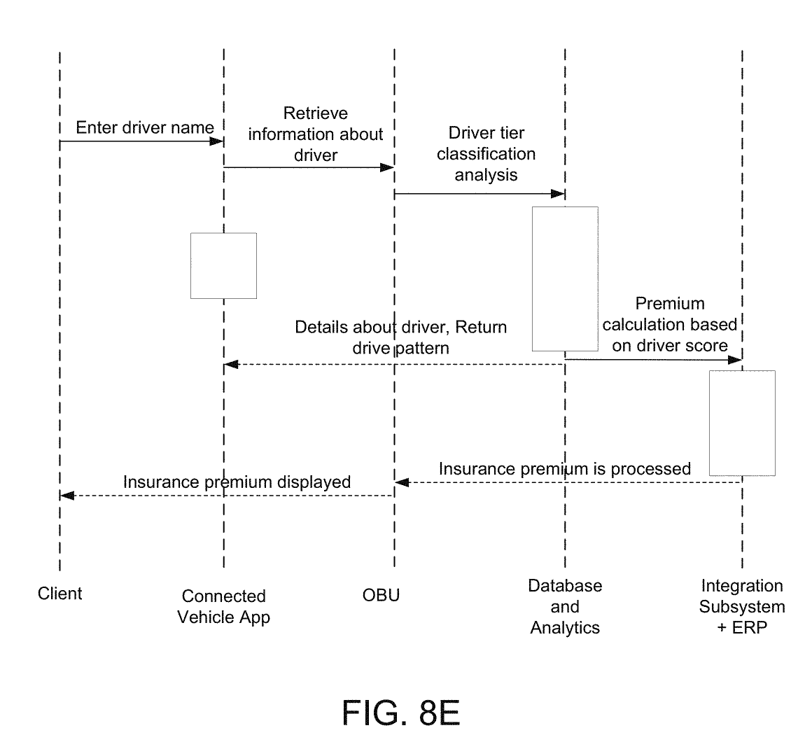

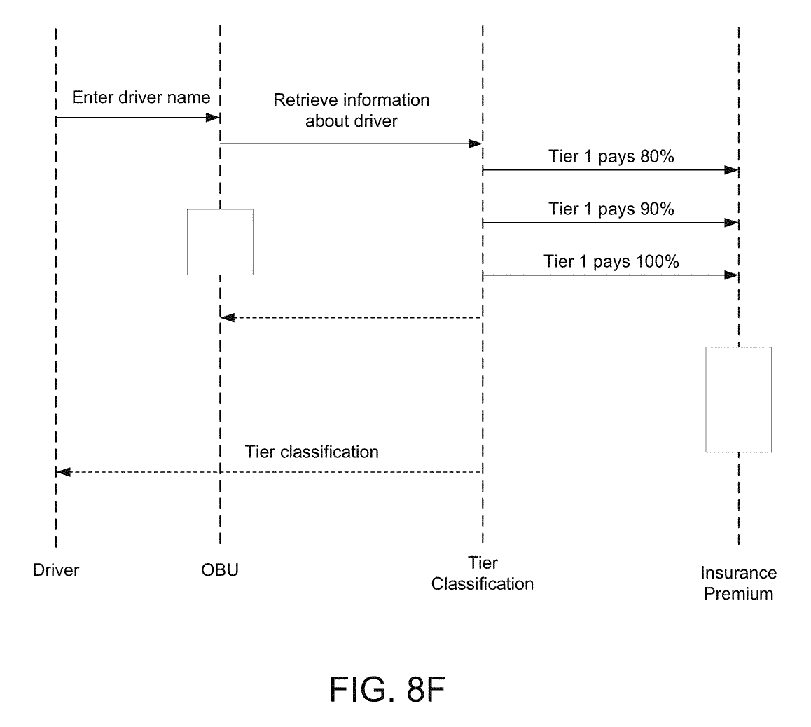

FIGS. 8A-8F illustrate a data flow diagrams showing information sent between components during settlement of claims using an integrated vehicular monitoring and communications, according to an example.

FIG. 8A illustrates a data flow diagram for retrieving vehicle details using a confirmation code. Here, a client, who may be a warranty insurance analyst, may be interested in looking at vehicle details on his or her dashboard 110. The client may enter a vehicle code which may and confirmation of the vehicle code may be confirmed by the integration subsystem 205 and/or ERP system 210. The analytics and database layer 203 and 204 may retrieve sensor data associated with the confirmation code. Acknowledgement of the confirmation code may then be passed back to the client for viewing at the dashboard 110.

FIG. 8B illustrates a data flow diagram for retrieving sensor details. A client, who may be a warranty insurance analyst, may be interested in looking at sensor details on his or her dashboard 110. The client may select a sensor filter option, which may further allow the client to select from a list of various vehicle sensors from which to acquire detailed information. In this case, the client may desire to view sensor details, trend details, and heatmap details. The OBUs may receive request for sensor details and heatmap details and send that back to the client. The analytics and database layer 203 and 204 may retrieve sensor data, and together with the integration subsystem 205 and/or ERP system 210, determine drive pattern, which may also be stored for future use. The drive pattern may also be used to provide and assign a tier classification to the operator of the vehicle. All this information may also be sent back to the client for viewing at the dashboard 110 based on his or her filtered request.

FIG. 8C illustrates a data flow diagram for an insurance premium calculation. A client, who may be a warranty insurance analyst, may be interested in calculating an insurance premium via his or her dashboard 110. The client may select provide some details regarding the request, such as adding zero depreciation and 24-7 roadside assistance (RA) options. These options may then be added to the premium calculation by the analytics and database layer 203 and 204, together with the integration subsystem 205 and/or ERP system 210. Once the insurance premium is determined, the amount is then displayed to the client at the dashboard 110. FIG. 6E may be an example of screen that is displayed at the dashboard 110.

FIG. 8D illustrates a data flow diagram for a claim for an accident. Here, a client, who may be a driver of a vehicle, may be interested in submitting a claim for an accident via his or her dashboard 110. The client may enter his or her name and this information may be used to retrieve information about the driver, such as drive pattern and tier classification, among other things, at the analytics and database layer 203 and 204. The integration subsystem 205 and/or ERP system 210 may calculate a driver score based on this information and process the claim based on this information. Once the claim is processed, details of the claim may be displayed for the client to view at the dashboard 110.

FIG. 8E illustrates a data flow diagram for an insurance premium calculation. Here, a client, who may be a driver of a vehicle, may be interested in requesting a premium calculation via his or her dashboard 110. The client may enter his or her name and this information may be used to retrieve information about the driver, such as drive pattern and tier classification, among other things, at the analytics and database layer 203 and 204. The integration subsystem 205 and/or ERP system 210 may calculate a driver score based on this information and calculate a premium amount based on this information. Once the premium is determined, details of the insurance premium may be displayed for the client to view at the dashboard 110.

FIG. 8F illustrates a data flow diagram for tier classification. Here, a driver of a vehicle may enter his or her name (or other identifier) via the dashboard 110. Instead of a driver, an insurer or other party having requisite credentials may also submit for tier classification. The analytics and database layer 203 and 204 may determine the assigned tier classification of the driver based on drive pattern analysis. The analytics and database layer 203 and 204, together with the integration subsystem 205 and/or ERP system 210, may determine the amount to be paid for insurance premium based on the assigned tier classifications. In this example, Tier 1 operators may receive a 20% discount for their excellent record of good driving patterns and pay 80% of an insurance premium. Tier 2 operators, who are relatively good drivers, may receive a 10% discount. Tier 3 operators may not receive any discounts, and may be considered as too high-risk to keep under a current policy. Other option may need to be considered for operations in this classification. Once these determinations are made or accessed, details of the tier classification and/or amount to be paid may be displayed for the client to view at the dashboard 110.

It should be appreciated that the data flows described above are examples of scenarios provided by the integrated vehicular monitoring and communication system 100 of FIGS. 1-3. Other examples or scenarios may also be contemplated. For instance, there may be a situation where functions and features of the system 100 may be employed via a cloud application. The cloud app may then facilitate claims settlement or insurance premium calculations.

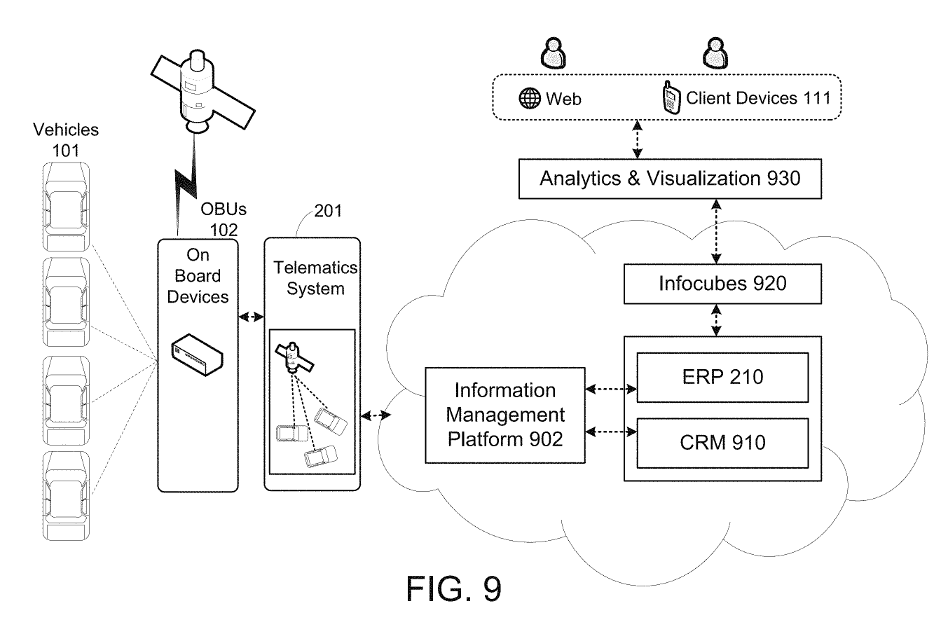

FIG. 9 illustrates an architecture of the integrated vehicular monitoring and communication system, according to another example. FIG. 9 is similar to FIG. 2, and therefore all the components in FIG. 2 that are common to FIG. 9 will not be described in any additional detail. FIG. 9, however, depicts an information management platform 902, ERP 210, a CRM 910, and infocubes 920 in communication with each other and integrated as such in a cloud platform. The cloud platform may also communicate with analytics and visualization 930, which may reside outside of the cloud platform. Infocubes 920 may be data storage where data is maintained. Infocubes 920 may function as a data target as well as an information provider. Infocubes 920 may include, but not limited to three classification types, such as standard infocubes, virtual infocubes, and real-time infocubes. Standard infocubes may be used to maintain the data physically, where read-only, for example, is possible. Virtual infocubes may not maintain data physically, but during query execution, the virtual infocubes may bring data from respective source systems. Real-time infocubes may store data physically and read and write capabilities are both possible. These may be helpful in data planning operations. It should be appreciated that these and other variations may be provided.

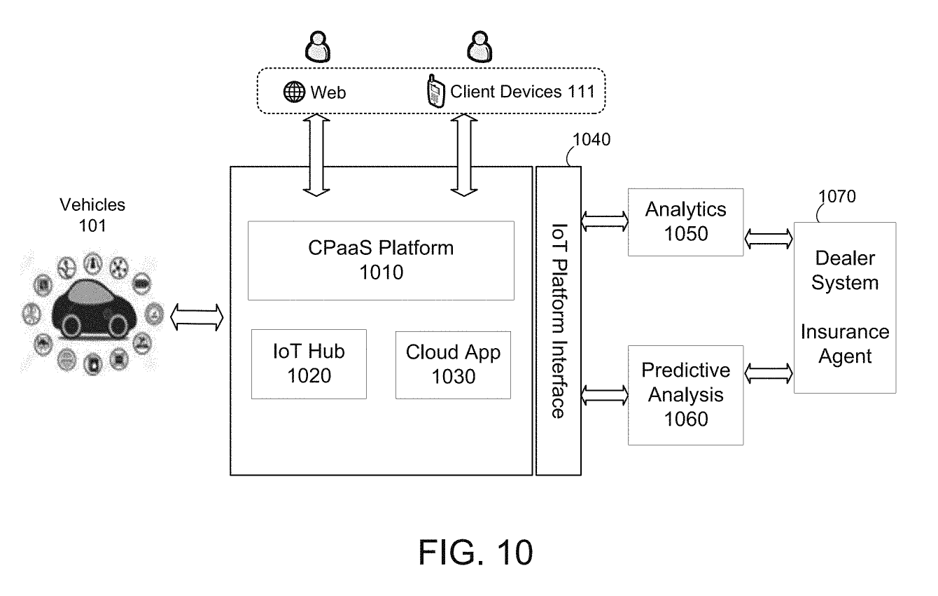

FIG. 10 illustrates an architecture of the integrated vehicular monitoring and communication system, according to another example. FIG. 10 is similar to FIG. 2, and therefore all the components in FIG. 2 that are common to FIG. 10 will not be described in any additional detail. FIG. 10, however, depicts an CPaaS platform 1010, an Internet of Things (IoT) hub 1020, a cloud app 1030, and an IoT platform interface 1040. Analytics 1050 and predictive analytics 1060 interface with the IoT platform interface 1040 and a dealer system or insurance agent 1070. This example may serve to illustrate an increased number of possibilities and scenarios for using an integrated vehicular monitoring and communication system described herein.

It should be appreciated that in addition to overcoming incompatibility issues associated with traditional systems, examples described herein with regard to the integrated vehicular monitoring and communication system may provide additional advantages and solutions. For example, insurance premium calculation and tier classification may be useful to a host of parties, such as insurance providers, dealers, underwriters, drivers, local and state government, etc. The system may provide solutions that motivate certain behaviors, e.g., improve driving habits, since drive pattern analysis can be used in premium calculations or settlement determinations. The system described herein may also be implemented seamlessly among current models, many of which still involve manual processing. The system may reduce overall cost and improve efficiencies in settlement of warranty and insurance claims. It may also reduce the number of erroneous warranty or insurance claims and other potentially fraudulent cases. Furthermore, the system may provide greater harmonization of data and access to data, which may reduce accidents and collisions, improve safety, and may even pave the way for or work in conjunction with other potential technological advances, such as autonomous or self-driving vehicles.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims and their equivalents.

1. An integrated vehicular monitoring and communications system, comprising:
a telematics server that communicates with a plurality of vehicles using an adaptive interface that communicates with a plurality of on-board units associated with the plurality of vehicles, the telematics server receiving vehicle state data from an on-board unit of a vehicle, where
the vehicle state data is transmitted from the vehicle to the telematics server over a wireless network, and
the telematics server stores connectivity parameters for one or more of web-service-based connectivity and file-based connectivity;
an integration subsystem connected to the telematics server via the at least one of web-service-based connectivity and file-based connectivity, the integration subsystem comprising:
at least one processor associated with a mapping and transformation element and a connectivity element, where
the integration subsystem determines a destination of the vehicle state data, and the destination comprises at least one of:
a database and analytics layer, and
an enterprise resource planning (ERP) subsystem,
the mapping and transformation element:
determines a format for the vehicle state data according to the destination and a source of the vehicle state data, and
transforms the vehicle state data to the determined format, and
the connectivity element determines connectivity parameters to establish communication with the destination, where
the database and analytics layer includes data storage and stores the vehicle state data in the data storage, and determines whether an actionable vehicle event occurs from the vehicle state data, and
in response to determining the actionable vehicle event occurred, the database and analytics layer transmitting information for the actionable vehicle event to the ERP subsystem via the integration subsystem, and receiving a service ticket generated by the ERP subsystem via the integration subsystem, wherein the database and analytics layer retrieves, from the data storage, vehicle information related to the service ticket; and
a mobility server transmitting the service ticket and vehicle information to a computer via a network.

2. The integrated vehicular monitoring and communications system of claim 1, where the integration subsystem:
determines a platform for the ERP subsystem;
determines the connectivity parameters and the format based on the determined platform in order to transmit the information for the actionable vehicle event to the ERP subsystem via the integration subsystem; and
formats the service ticket for storage in the data storage of the database and analytics layer, and sends the service ticket according to the connectivity parameters, wherein the connectivity parameters are determined for the database and analytics layer in order to receive the service ticket at the database and analytics layer via the integration subsystem.

3. The integrated vehicular monitoring and communications system of claim 1, where the database and analytics layer comprises:
a rules module and an action generator executed by at least one processor, where the rules module generates and stores rules based on user input, and the rules specify conditions to identify actionable vehicle events, and the action generator determines whether the actionable vehicle event occurs based on at least one rule.

4. The integrated vehicular monitoring and communications system of claim 3, where the action generator determines whether a vehicle service is needed based on the vehicle state data and the at least one rule.

5. The integrated vehicular monitoring and communications system of claim 4, wherein the action generator:
invokes generation of the service ticket via the ERP subsystem, and
provides the vehicle information and the service ticket to a service technician via a dashboard provided by the mobility server.

6. The integrated vehicular monitoring and communications system of claim 5, wherein the action generator:
determines whether the vehicle is not being used in accordance with stored parameters based on the vehicle state data and the at least one rule; and
generates, if the vehicle is determined as not being used in accordance with the stored parameters, an alert to a party who is monitoring the vehicle.

7. The integrated vehicular monitoring and communications system of claim 5, wherein the action generator:
determines whether the vehicle is being used outside of a previously agreed upon terms and conditions based on the vehicle state data, the at least one rule, and at least one of a warranty terms and conditions and an insurance policy; and
generates, if the vehicle is determined as being used outside of the previously agreed upon terms and conditions, an alert to a party who is monitoring the vehicle.

8. An integrated vehicular monitoring and communications system, comprising:
a telematics server that receives vehicle state data from an on-board unit of a vehicle, where
the vehicle state data is transmitted from the vehicle over a wireless network to the telematics server, and
the telematics server stores connectivity parameters for at least one of web-service-based connectivity and file-based connectivity;
an integration subsystem that is connected to the telematics server via the at least one of web-service-based connectivity and file-based connectivity, the integration subsystem comprising:
at least one processor associated with a mapping and transformation element and a connectivity element, where
the integration subsystem
receives vehicle operator information associated with the vehicle and a vehicle operator, and
determines a destination of the vehicle state data, and the destination comprises at least one of a database and analytics layer and an enterprise resource planning (ERP) subsystem,
the mapping and transformation element determines a format for the vehicle state data according to the destination and a source of the vehicle state data, and transforms the vehicle state data to the determined format, and
the connectivity element determines connectivity parameters to establish communication with the destination, where
the database and analytics layer includes data storage and stores the vehicle state data in the data storage, and determines drive pattern based on the vehicle state data, and
the database and analytics layer transmitting the drive pattern and the vehicle operator information to the ERP subsystem via the integration subsystem, where at least one of the ERP subsystem and the integration subsystem
assigns a tier classification to the vehicle operator based at least in part on the drive pattern, and
calculates an amount of a claim based at least in part on the tier classification, and
the database and analytics layer receives the tier classification for the vehicle operator and calculated amount of the claim from the at least one of the ERP subsystem and the integration subsystem; and
a mobility server transmitting the amount of the claim to a computer via a network.

9. The integrated vehicular monitoring and communications system of claim 8, where the vehicle operator information comprises at least one of a name, an address, a driver's license number, and biometric data.

10. The integrated vehicular monitoring and communications system of claim 8, where the vehicle state data comprises at least one of speed, acceleration, brake frequency, tire pressure, tire tread depth, rotations per minute (RPM), weather conditions, and vehicle maintenance.

11. The integrated vehicular monitoring and communications system of claim 8, where the tier classification of the vehicle operator comprises a first tier, a second tier, and a third tier, where the first tier is eligible for a high level discount, the second tier is eligible for a mid-level discount, and the third tier is not eligible for any discount.

12. The integrated vehicular monitoring and communications system of claim 11, where the amount of the claim is reduced by the high level discount, the mid-level discount, or no discount based on the tier classification of the vehicle operator.

13. The integrated vehicular monitoring and communications system of claim 8, where the amount of the claim is one of a premium for an insurance policy, a premium for an insurance claim, and an amount of a warranty settlement claim.

14. A method for integrated vehicular monitoring and communications, the method comprising:
receiving, at an integration subsystem, vehicle state data from a telematics server collecting vehicle state data from onboard units of a plurality of vehicles and vehicle operator information associated with each of the plurality of vehicles and at least one vehicle operator for each of the plurality of vehicles;
receiving vehicle operator information where the vehicle operator information is associated with a request for an amount of a claim;
determining connectivity parameters and a format for storing data in a database and analytics layer platform associated with the integration subsystem;
formatting the vehicle state data for the database and analytics layer platform;
sending the formatted vehicle state data to the database and analytics layer platform according to the connectivity parameters;
determining, at the database and analytics layer, drive pattern based on the vehicle state data, vehicle operator information, and at least one rule;
assigning a tier classification to the vehicle operator based at least in part on the drive pattern and the at least one rule;
calculating the amount of the claim based at least in part on the tier classification and input from an ERP subsystem;
receiving, at the database and analytics layer platform, the tier classification for the vehicle operator and the calculated amount of the claim from the at least one of the ERP subsystem and the integration subsystem; and
transmitting the amount of the claim to a computer for display at a dashboard, comprising a graphical user interface, over a network.

15. The method for integrated vehicular monitoring and communications of claim 14, where the vehicle operator information comprises at least one of a name, an address, a driver's license number, and biometric data.

16. The method for integrated vehicular monitoring and communications of claim 14, where the vehicle state data comprises at least one of speed, acceleration, brake frequency, tire pressure, tire tread depth, rotations per minute (RPM), weather conditions, and vehicle maintenance.

17. The method for integrated vehicular monitoring and communications of claim 14, where the tier classification of the vehicle operator comprises a first tier, a second tier, and a third tier, where the first tier is eligible for a high level discount, the second tier is eligible for a mid-level discount, and the third tier is not eligible for any discount.

18. The method for integrated vehicular monitoring and communications of claim 17, where the amount of the claim is reduced by the high level discount, the mid-level discount, or no discount based on the tier classification of the vehicle operator.

19. The method for integrated vehicular monitoring and communications of claim 14, where the amount of the claim is least one of a premium for an insurance policy, a premium for an insurance claim, or an amount of a warranty settlement claim.
